(19) United States
(12) Patent Application Publication
(10) Pub. No.: US 2016/0073023 A1
(43) Pub. Date: Mar. 10, 2016

(54) PANORAMIC CAMERA SYSTEMS

(71) Applicant: 360fly, Inc., Canonsburg, PA (US)

(72) Inventors: Michael Rondinelli, Canonsburg, PA (US); Minkyu Choi, Saint-Laurent (CA); Mladen Barbaric, Ottawa (CA); Sungmoon Kim, Saint-Laurent (CA); Bonggeun Kim, Westmount (CA); Drew Timothy, Pittsburgh, PA (US); Mike Barthelemy, Canonsburg, PA (US); Nick Steele, Pittsburgh, PA (US); Geoffrey Anderson, Pittsburgh, PA (US)

(21) Appl. No.: 14/846,341

(22) Filed: Sep. 4, 2015

Related U.S. Application Data
(60) Provisional application No. 62/046,801, filed on Sep. 5, 2014.

(51) Int. Cl. H04N 5/232

(52) U.S. Cl. CPC H04N 5/23238

(57) ABSTRACT

Panoramic camera systems are disclosed. The panoramic camera systems include a panoramic lens with a wide field of view, a video sensor and a processor module contained in a camera body that remains outside the field of view of the lens. The panoramic camera systems may also capture audio sounds and may include various types of motion sensors. Mounting assemblies and charging cradles for the camera systems are also disclosed. Methods for processing panoramic video image data are disclosed. Methods and devices for displaying video images are also disclosed.

### CROSS-REFERENCE TO RELATED APPLICATION

This application claims the benefit of U.S. Provisional Patent Application Ser. No. 62/046,801 filed Sep. 5, 2014, which is incorporated herein by reference.

### FIELD OF THE INVENTION

The present invention relates to panoramic camera systems, and more particularly relates to camera systems for capturing, processing and displaying panoramic images, and camera-mounting hardware for use with such systems.

### BACKGROUND INFORMATION

Panoramic imaging systems including optical devices, unwarping software, displays and various applications are disclosed in U.S. Pat. Nos. 6,963,355; 6,594,448; 7,058,239; 7,399,095; 7,139,440; 6,856,472; 7,123,777; 8,730,322; and 8,836,783; and published U.S. Patent Application Publication Nos. US2015/0002622A1; US2012/0262540A1; US2015/0234156A1; US2013/0063553A1; and US2014/0022649A1, which are assigned to the assignee of the present application. All of these prior patents and applications are incorporated herein by reference.

### SUMMARY OF THE INVENTION

The present invention provides panoramic camera systems incorporating a panoramic lens with a wide field of view, a video sensor and a processor module contained in a camera body designed to remain outside the field of view of the lens. The panoramic camera systems capture panoramic images, and may also capture audio sounds. Various types of motion sensors may be used in the camera systems. Mounting assemblies and charging cradles are also provided. Methods for processing panoramic video image data are provided. Methods and devices for displaying video images are also provided.

An aspect of the present invention is to provide a panoramic camera comprising: a camera body; and a panoramic lens having a principle longitudinal axis and a field of view angle of greater than 180°, wherein a portion of the camera body adjacent to the panoramic lens comprises a surface defining a rake angle that is outside the field of view angle.

Another aspect of the present invention is to provide a camera and mount assembly comprising: a camera system comprising a camera body and a mount attachment hole therein; and a mount assembly comprising a mounting stud including at least one cammed retention nub, wherein the mount attachment hole comprises as least one retaining tab releasingly engageable with the at least one cammed retention nub of the mounting stud.

A further aspect of the present invention is to provide a camera mount assembly comprising: a lower base; and an upper mounting plate comprising a mounting stud extending therefrom, wherein the mounting stud comprises at least one cammed retention nub structured and arranged for releasably retaining a mount attachment hole of camera body thereon.

Another aspect of the present invention is to provide a camera mount assembly comprising: a mounting base receiver; a mounting base attached to the mounting base receiver; and a mounting stud extending from the mounting base, wherein the mounting stud comprises at least one cammed retention nub structured and arranged for releasably retaining a mount attachment hole of the camera body.

A further aspect of the present invention is to provide a camera system charging cradle comprising: a base including bottom and top surfaces with a sidewall extending therebetween; and a recessed nest extending inward from the top surface of the base, wherein the recessed nest comprises at least one magnet adjacent thereto structured and arranged to magnetically attract and align the camera system in a selected orientation in the recessed nest when the camera system is placed into the recessed nest.

Another aspect of the present invention is to provide a method for processing panoramic video content captured by a panoramic camera device, the method comprising: executing, by a processor of the camera device, raw panoramic video associated with captured video content; executing, by the camera device processor, a tiling process on at least a portion of the raw panoramic video; encoding, by the camera device processor, the tiled video content; transmitting, from the camera device to a user computing device, the encoded video content; decoding, by a processor of the user computing device, the transmitted video content; executing, by the user computing device processor, a de-tiling process for at least a portion of the decoded video content; and displaying, on a display of the user computing device, at least a portion of the video content.

A further aspect of the present invention is to provide a method for processing data associated with video content captured by a panoramic camera device, the method comprising: receiving motion sensor data associated with at least a portion of the panoramic video content captured by the camera; and calculating at least one parameter in response to at least a portion of the received motion sensor data.

These and other aspects of the present invention will be more apparent from the following description.

### BRIEF DESCRIPTION OF THE DRAWINGS

FIG. 1 is a partially schematic side view of a camera system in accordance with an embodiment of the present invention.

FIG. 2 is a side view of a camera system in accordance with an embodiment of the present invention.

FIG. 3 is an exploded assembly view of the camera system of FIG. 2.

FIGS. 4, 5, 6, 7 and 8 are front, side, rear, top and bottom views, respectively, of a camera system in accordance with an embodiment of the present invention.

FIG. 9 is a side sectional view taken from section 9-9 of FIG. 5.

FIG. 10 is a cross-sectional view taken from section 10-10 of FIG. 4.

FIG. 11 is a partially schematic side sectional view of a camera system in accordance with another embodiment of the present invention.

FIG. 12 is a side view of a lens for use in a camera system in accordance with an embodiment of the present invention.

FIG. 13 is a side view of a lens for use in a camera system in accordance with another embodiment of the present invention.

FIG. 14 is a side view of a lens for use in a camera system in accordance with a further embodiment of the present invention.

FIG. 15 is a side view of a lens for use in a camera system in accordance with another embodiment of the present invention.

FIGS. 16, 17 and 18 are front, side and rear views, respectively, of a camera system mounted on a tilt mount assembly and baseplate in accordance with an embodiment of the present invention.

FIG. 19 is an isometric view of a tilt mount assembly in accordance with an embodiment of the present invention.

FIG. 20 is an exploded isometric view of the tilt mount assembly of FIG. 19.

FIGS. 21, 22 and 23 are side, top and bottom views, respectively, of a tilt mount assembly in accordance with an embodiment of the present invention.

FIG. 24 is a side sectional view taken from section 24-24 of FIG. 22.

FIG. 25 is a side sectional view taken from section 25-25 of FIG. 22.

FIG. 26 is an isometric view of a tilt mount assembly in a tilted position in accordance with an embodiment of the present invention.

FIG. 27 is a side view of the tilt mount assembly of FIG. 26.

FIG. 28 is a bottom view of an upper mounting plate of a tilt mount assembly in accordance with an embodiment of the present invention.

FIG. 29 is a front view of the upper mounting plate of FIG. 28.

FIGS. 30, 31 and 32 are front, side and rear views, respectively, of a camera system mounted on a charging cradle in accordance with an embodiment of the present invention.

FIG. 33 is an isometric view of a charging cradle in accordance with an embodiment of the present invention.

FIGS. 34, 35 and 36 are front, rear and top views, respectively, of the charging cradle of FIG. 33.

FIG. 37 is a side sectional view taken from section 37-37 of FIG. 34.

FIG. 38 is a cross-sectional view taken from section 38-38 of FIG. 34.

FIG. 39 is an isometric view of a curved baseplate in accordance with an embodiment of the present invention.

FIG. 40 is a top view of the curved baseplate of FIG. 39.

FIG. 41 is a side sectional view taken from section 41-41 of FIG. 40.

FIG. 42 is a top view of a flat baseplate in accordance with an embodiment of the present invention.

FIG. 43 is a side sectional view taken from section 43-43 of FIG. 42.

FIG. 44 is a side view of a portion of a camera body and microphone hole plug in accordance with an embodiment of the present invention.

FIG. 45 is an isometric view, FIG. 46 is a side view, and FIG. 47 is an isometric exploded assembly view of a clamp mount assembly in accordance with an embodiment of the present invention.

FIG. 48 is a side view and FIG. 49 is an isometric exploded assembly view of an action camera adapter mount assembly in accordance with an embodiment of the present invention.

FIG. 50 is a side view and FIG. 51 is an isometric exploded assembly view of a tripod adapter mount assembly in accordance with an embodiment of the present invention.

FIG. 52 is an oblique side view of a head mount assembly in accordance with an embodiment of the present invention.

FIG. 53 is an isometric view of a portion of a body mount assembly in accordance with an embodiment of the present invention.

FIG. 54 is an isometric view and FIG. 55 is an isometric exploded assembly view of a suction mount assembly in accordance with an embodiment of the present invention.

FIG. 56 is an isometric view and FIG. 57 is an isometric exploded assembly view of a helmet mount assembly in accordance with an embodiment of the present invention.

FIG. 58 is a schematic flow diagram illustrating tiling and de-tiling processes in accordance with an embodiment of the present invention.

FIG. 59 is a schematic flow diagram illustrating a camera side process in accordance with an embodiment of the present invention.

FIG. 60 is a schematic flow diagram illustrating a user side process in accordance with an embodiment of the present invention.

FIG. 61 is a schematic flow diagram illustrating a sensor fusion model in accordance with an embodiment of the present invention.

FIG. 62 is a schematic flow diagram illustrating data transmission between a camera system and user in accordance with an embodiment of the present invention.

FIGS. 63, 64 and 65 illustrate interactive display features in accordance with embodiments of the present invention.

FIGS. 66, 67 and 68 illustrate orientation-based display features in accordance with embodiments of the present invention.

### DETAILED DESCRIPTION

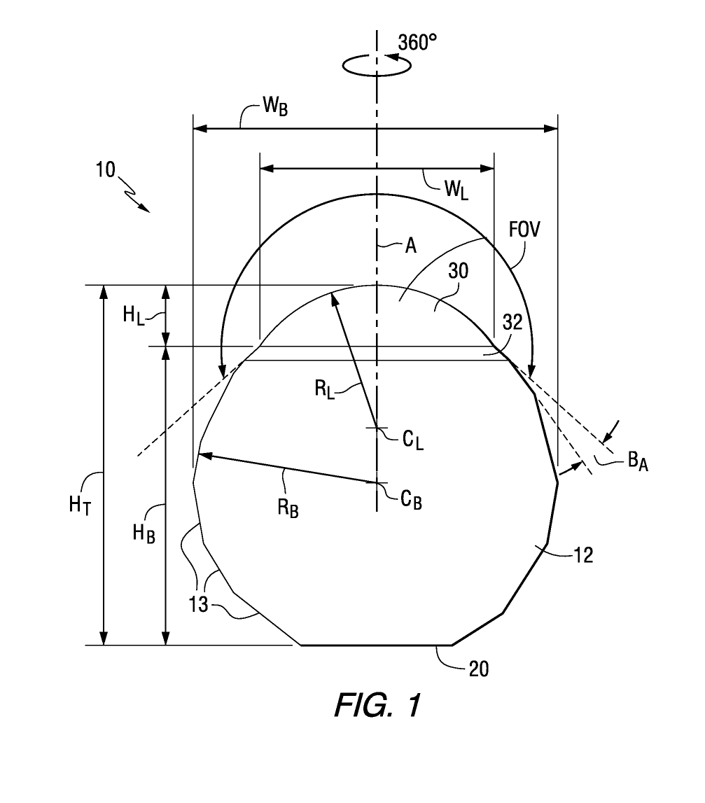

FIGS. 1-9 illustrate a camera system 10 in accordance with an embodiment of the present invention. The camera system 10 includes a camera body 12 having a generally spherical shape. In the embodiment shown, the generally spherical camera body 12 includes a faceted surface comprising facets 13 having substantially flat surfaces lying in planes slightly offset from each adjacent facet. Thus, while the camera body 12 has an overall shape that is generally spherical, its surface is made up of many facets 13. In the embodiment shown, most of the individual facets 13 have a triangular shape. However, some of the facets 13 may have quadrilateral or other shapes. Although a faceted body 12 is shown in the figures, it is to be understood that the camera system 10 may have any other suitable surface configuration, such as smooth, dimpled, knurled or ribbed spherical surfaces. In addition to generally spherical shapes, the body 12 of the camera system 10 may have any other suitable overall shape, such as cylindrical, ovular or the like. The camera body 12 may be made of any suitable material such as plastic or metal. Examples of suitable plastics include conventional high impact thermoplastics such as polycarbonates, nylons and the like, which may optionally be reinforced with metal, carbon or polymeric particles, fibers, platelets or the like. In certain embodiments, the camera body 12 comprises a thermoplastic material with thermally conductive particles, fibers, platelets or the like dispersed therein to increase the thermal conductivity of the camera body material.

The camera system 10 includes a panoramic lens 30 installed in the camera body 12 by a lens support ring 32, which may be made of any suitable material including metals such as aluminum and the like. As shown in FIG. 1, the lens 30 has a principle longitudinal axis A defining a 360° rotational view. In FIG. 1, the longitudinal axis A is vertical and the camera system 10 and panoramic lens 30 are oriented to provide a 360° rotational view along a horizontal plane perpendicular to the longitudinal axis A. However, the camera system 10 and panoramic lens 30 may be oriented in any other desired orientation during use. As further shown in FIG. 1, the panoramic lens 30 also has a field of view FOV, which, in the orientation shown in FIG. 1, corresponds to a vertical field of view. In certain embodiments, the field of view FOV is greater than 180° up to 360°, e.g., from 200° to 300°, from 210° to 280°, or from 220° to 270°. In certain embodiments, the field of view FOV may be about 230°, 240°, 250° or 260°.

In the embodiment shown, the lens support ring 32 is beveled at an angle such that it does not interfere with the field of view FOV of the lens 30. In the embodiment shown in FIG. 1, the bevel angle of the support ring 32 is equal to the field of view FOV angle of the lens. In addition, the upper portion of the camera body 12 has a tangential surface or surfaces that are angled downward at a base rake angle B_{A} in order to avoid obstruction of the field of view FOV. In the embodiment shown in FIG. 1, the bevel angle of the lens support ring 32, which also corresponds to the field of view FOV angle, is more shallow than the base rake angle B_{A} of the upper portion of the camera body 12.

As shown in FIG. 1, the relative dimensions of the camera body 12 and panoramic lens 30 may be controlled in order to optimize the structure and performance of the camera system 10. The camera body 12 has a height H_{B} measured from the bottom 20 of the camera body 12 to the top of the lens support ring 32. The lens 30 has a height H_{L}, corresponding to the exposed portion of the lens 30 that extends above the support ring 32. The camera system 10 has a total height H_{T} equal to the combined camera body height H_{B} and lens height H_{L}. In certain embodiments, the ratio of the lens height H_{L} to the camera body height H_{B} may range from 1:20 to 1:2, for example, H_{L}:H_{B} ratio may range from 1:10 to 1:3, or from 1:7 to 1:4.

As further shown in FIG. 1, the camera body 12 has a width W_{B}, and the lens 30 has a width W_{L}. In certain embodiments, the ratio of the lens width W_{L} to the camera body width W_{B} may be at least 1:3, or at least 1:2. In certain embodiments, the W_{L}:W_{B} ratio may range from 1:4 to 1:0.4, for example, from 1:3 to 1:0.8, or from 1:2 to 1:1. As further shown in FIG. 1, the ratio of the camera body width W_{B} to total height H_{T} may typically range from 1:3 to 1:0.3. For example, the W_{B}:H_{T} ratio may range from 1:2 to 1:0.5, or from 1:1.5 to 1:0.7. In certain embodiments, the W_{B}:H_{T} ratio may be about 1:1.

As shown in FIG. 1, the camera body 12 has a central point C_{B} at the center of the generally spherical surface of the camera body 12. The camera body 12 has a radius R_{B} measured from the center C_{B} to the outer surface of the camera body 12. Since the outer surface of the camera body 12 may include multiple facets 13, it is to be understood that the body radius R_{B} may vary slightly when measured from the body center C_{B} to various points on the outer surface of the camera body 12, and that the body radius R_{B} will be the average of the radii measured at such various points. The panoramic lens 30 has an upper surface comprising a radius of curvature having a center C_{L}. In certain embodiments, the outer surface of the lens 30 may be spherical with a radius R_{L} measured from the lens radius of curvature center C_{L}. The ratio of R_{L}:R_{B} may be less than 1:1, for example, from 1:1.05 to 1:2, or from 1:1.1 to 1:1.5. The body center C_{B} may be offset from the lens center C_{L} along the longitudinal camera axis A. For example, as shown in FIG. 1, the body center C_{B} is located vertically below the lens center C_{L} along the longitudinal axis A. The distance between C_{B} and C_{L} may be at least 5 percent or 10 percent of the camera body height H_{T}. Furthermore, the distance between C_{B} and C_{L} may be at least 5 or 10 percent of the lens width W_{L}. In addition, the distance between C_{B} and C_{L} may be at least 10 percent or 20 percent of the lens radius R_{L}.

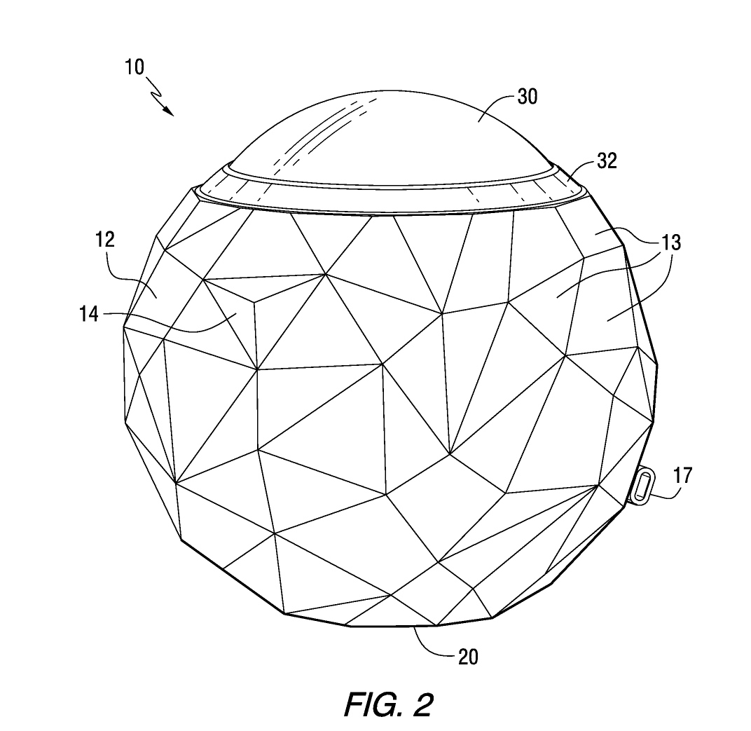

FIGS. 2-10 illustrate additional features of the camera system 10. FIG. 2 shows surface details of the camera body 12 including its faceted surfaces 13 and an on/off power button 14. In the embodiment shown, the power button 14 comprises a pyramidal outer surface with a triangular base. However, the power button may have any other suitable shape or size. A microphone hole plug 17 is also shown in FIG. 2.

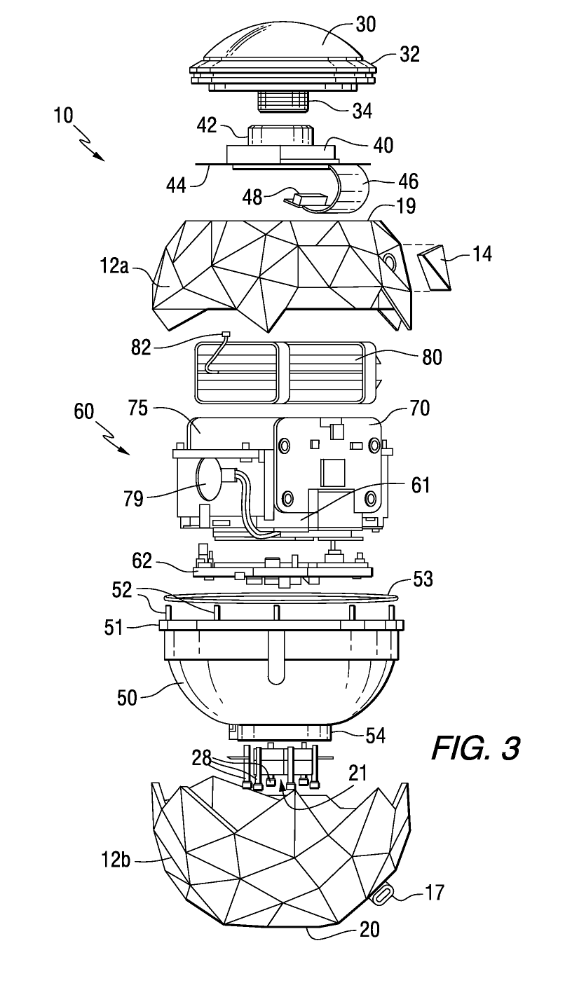

FIG. 3 is an exploded assembly view of the camera system 10. The panoramic lens 30 and lens support ring 32 are connected to a hollow mounting tube 34 that is externally threaded. A video sensor 40 is located below the panoramic lens 30, and is connected thereto by means of a mounting ring 42 having internal threads engageable with the external threads of the mounting tube 34. The sensor 40 is mounted on a sensor board 44. A sensor ribbon cable 46 is connected to the sensor board 44 and has a sensor ribbon cable connector 48 at the end thereof.

The sensor 40 may comprise any suitable type of conventional sensor, such as CMOS or CCD imagers, or the like. For example, the sensor 40 may be a high resolution sensor sold under the designation IMX117 by Sony Corporation. In certain embodiments, video data from certain regions of the sensor 40 may be eliminated prior to transmission, e.g., the corners of a sensor having a square surface area may be eliminated because they do not include useful image data from the circular image produced by the panoramic lens assembly 30, and/or image data from a side portion of a rectangular sensor may be eliminated in a region where the circular panoramic image is not present. In certain embodiments, the sensor 40 may include an on-board or separate encoder. For example, the raw sensor data may be compressed prior to transmission, e.g., using conventional encoders such as jpeg, H.264, H.265, and the like. In certain embodiments, the sensor 40 may support three stream outputs such as: recording H.264 encoded .mp4 (e.g., image size 1504×1504); RTSP stream (e.g., image size 750×750); and snapshot (e.g., image size 1504×1504). However, any other desired number of image streams, and any other desired image size for each image stream, may be used.

A tiling and de-tiling process may be used in accordance with the present invention. Tiling is a process of chopping up a circular image of the sensor 40 produced from the panoramic lens 30 into pre-defined chunks to optimize the image for encoding and decoding for display without loss of image quality, e.g., as a 1080p image on certain mobile platforms and common displays. The tiling process may provide a robust, repeatable method to make panoramic video universally compatible with display technology while maintaining high video image quality. Tiling may be used on any or all of the image streams, such as the three stream outputs described above. The tiling may be done after the raw video is presented, then the file may be encoded with an industry standard H.264 encoding or the like. The encoded streams can then be decoded by an industry standard decoder and the user side. The image may be decoded and then de-tiled before presentation to the user. The de-tiling can be optimized during the presentation process depending on the display that is being used as the output display. The tiling and de-tiling process may preserve high quality panoramic images and optimize resolution, while minimizing processing required on both the camera side and on the user side for lowest possible battery consumption and low latency. The image may be dewarped through the use of dewarping software or firmware after the de-tiling reassembles the image. The dewarped image may be manipulated by an app, as more fully described below.

As shown in the exploded assembly view shown in FIG. 3, the camera body 12 comprises an upper portion of the outer camera shell 12a and a lower portion of the outer camera shell 12b. The power button 14 may be located on the upper portion 12a, while the microphone hole plug 17 may be located in the lower portion 12b. An internal base sarcophagus 50 having a generally spherical lower surface fits within the lower portion 12b of the camera body 12. The internal base 50 includes an upper annular rim 51 with pegs 52 extending axially upward therefrom. A gasket 53 engages the upper rim 51 when the camera system 10 is assembled. The internal base 50 includes a lower annular pedestal 54 defining a recess into which a mount attachment hole assembly 21 and contact pins 28 are installed, as more fully described below.

As further shown in FIG. 3, the camera system 10 includes a processor module 60 comprising a support cage 61. A processor board 62 is attached to the support cage 61. In addition, communication board(s) such as a WIFI board 70 and Bluetooth board 75 may be attached to the processor support cage 61. Although separate processor, WIFI and Bluetooth boards 62, 70 and 75 are shown in FIG. 3, it is understood that the functions of such boards may be combined onto a single board. Furthermore, additional functions may be added to such boards such as cellular communication and motion sensor functions, which are more fully described below. A vibration motor 79 may also be attached to the support cage 61.

The processor board 62 may function as the command and control center of the camera system 10 to control the video processing, data storage and wireless or other communication command and control. Video processing may comprise encoding video using industry standard H.264 profiles or the like to provide natural image flow with a standard file format. Decoding video for editing purposes may also be performed. Data storage may be accomplished by writing data files to an SD memory card or the like, and maintaining a library system. Data files may be read from the SD card for preview and transmission. Wireless command and control may be provided. For example, Bluetooth commands may include processing and directing actions of the camera received from a Bluetooth radio and sending responses to the Bluetooth radio for transmission to the camera. WIFI radio may also be used for transmitting and receiving data and video. Such Bluetooth and WIFI functions may be performed with the separate boards 75 and 70 illustrated in FIG. 3, or with a single board. Cellular communication may also be provided, e.g., with a separate board, or in combination with any of the boards described above.

A battery 80 with a battery connector 82 is configured to fit within the processor support cage 61. Any suitable type of battery or batteries may be used, such as conventional rechargeable lithium ion batteries and the like. When the camera system 10 is assembled, the internal base 50 fits inside the lower portion 12b of the outer camera shell 12, and the processor support cage 61 and the processor module 60 with the battery 80 therein is located at least partially in the internal base 50 and is covered by the upper portion 12a of the outer camera shell 12.

The camera system 10 may include one or more motion sensors, e.g., as part of the processor module 60. As used herein, the term “motion sensor” includes sensors that can detect motion, orientation, position and/or location, including linear motion and/or acceleration, rotational motion and/or acceleration, orientation of the camera system (e.g., pitch, yaw, tilt), geographic position, gravity vector, altitude, height, and the like. For example, the motion sensor(s) may include accelerometers, gyroscopes, global positioning system (GPS) sensors, barometers and/or compasses that produce data simultaneously with the optical and, optionally, audio data. Such motion sensors can be used to provide the motion, orientation, position and location information used to perform some of the image processing and display functions described herein. This data may be encoded and recorded. The captured motion sensor data may be synchronized with the panoramic visual images captured by the camera system 10, and may be associated with a particular image view corresponding to a portion of the panoramic visual images, for example, as described in U.S. Pat. Nos. 8,730,322 and 8,836,783.

Orientation based tilt can be derived from accelerometer data. This can be accomplished by computing the live gravity vector relative to the camera system 10. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the device vertically may center the view on the horizon), or it may be used with an arbitrary offset for the convenience of the operator. This offset may be determined based on the initial orientation of the device when playback begins (e.g., the angular position of the device when playback is started can be centered on the horizon).

Any suitable accelerometer may be used, such as conventional 3-axis and 9-axis accelerometers. For example, a 3 axis BMA250 accelerometer from BOSCH or the like may be used. A 3-axis accelerometer may enhance the capability of the camera to determine its orientation in 3D space using an appropriate algorithm. The camera system 10 may capture and embed the raw accelerometer data into the metadata path in a MPEG4 transport stream, providing the full capability of the information from the accelerometer that provides the user side with details to orient the image to the horizon.

The motion sensor may comprise a GPS sensor capable of receiving satellite transmissions, e.g., the system can retrieve position information from GPS data. Absolute yaw orientation can be retrieved from compass data, acceleration due to gravity may be determined through a 3-axis accelerometer when the computing device is at rest, and changes in pitch, roll and yaw can be determined from gyroscope data. Velocity can be determined from GPS coordinates and timestamps from the software platform's clock. Finer precision values can be achieved by incorporating the results of integrating acceleration data over time. The motion sensor data can be further combined using a fusion method that blends only the required elements of the motion sensor data into a single metadata stream or in future multiple metadata streams.

The motion sensor may comprise a gyroscope which measures changes in rotation along multiple axes over time, and can be integrated over time intervals, e.g., between the previous rendered frame and the current frame. For example, the total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset. Automatic roll correction can be computed as the angle between the device's vertical display axis and the gravity vector from the device's accelerometer.

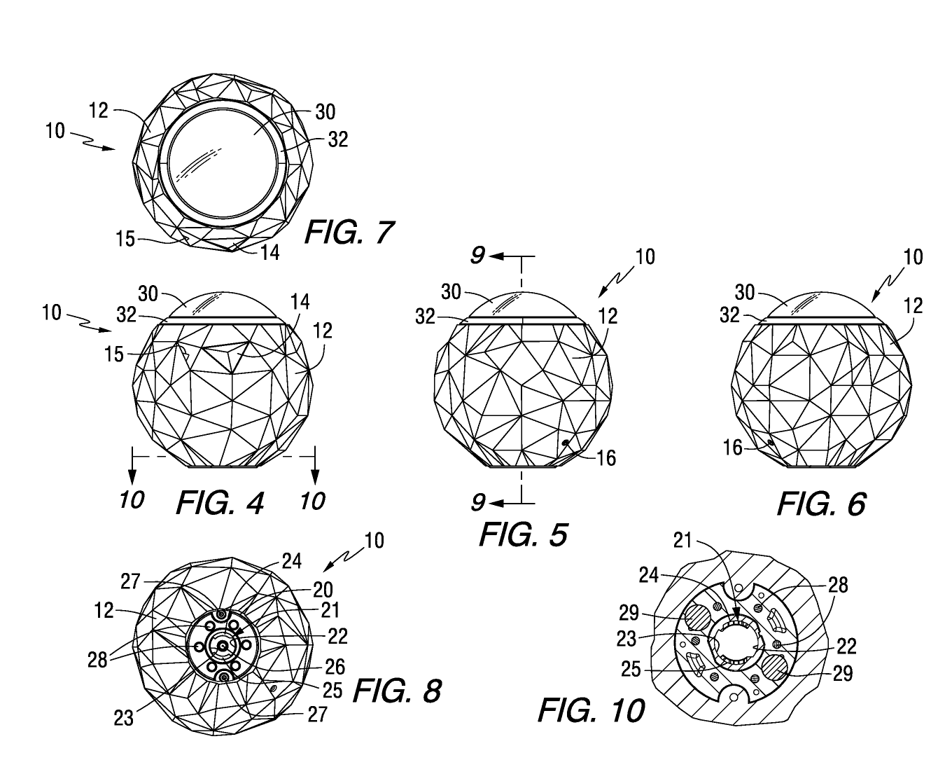

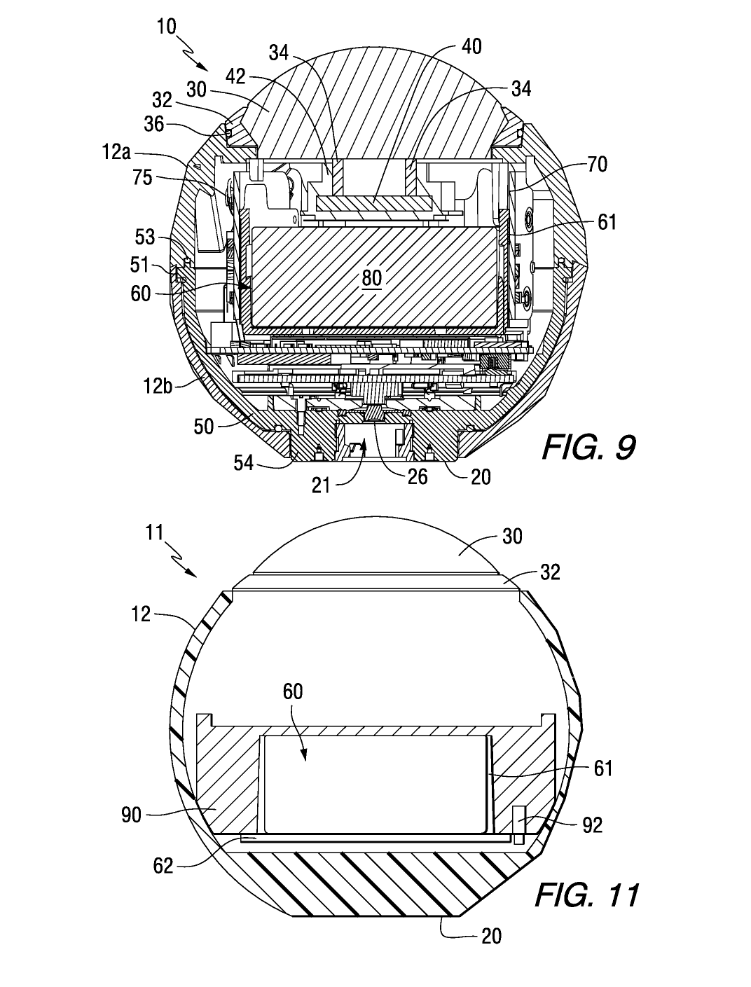

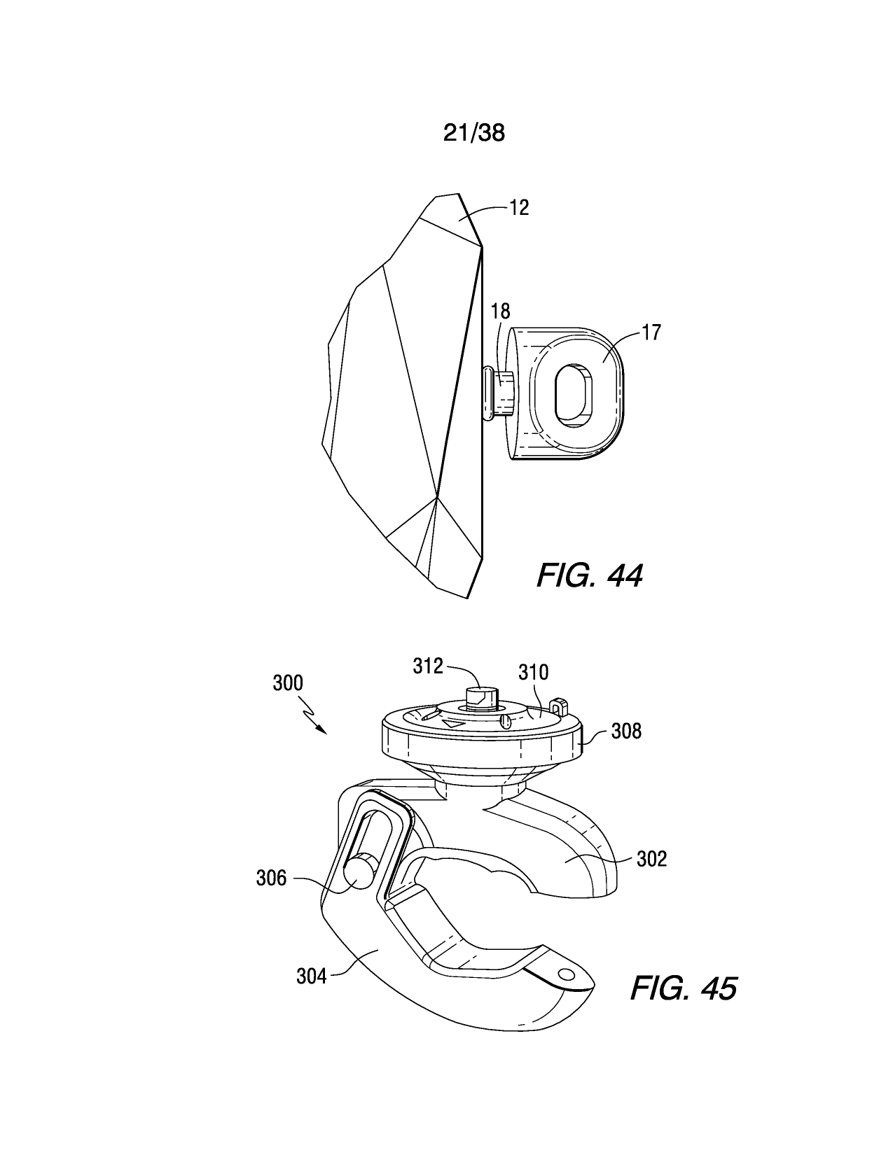

Further details of the camera system 10 are illustrated in FIGS. 4-10. FIG. 4 is a front view, FIG. 5 is a side view, FIG. 6 is a rear view, FIG. 7 is a top view and FIG. 8 is a bottom view of the camera system 10. FIG. 9 is a side sectional view taken from section 9-9 of FIG. 5. FIG. 10 is a bottom cross-sectional view taken from section 10-10 of FIG. 4. As shown in FIGS. 4 and 7, an indicator light 15 is provided on the camera body adjacent to the power button 14. As shown in FIGS. 5, 6 and 8, a microphone hole 16 passes through a lower portion of the camera body 12. The microphone hole 16 may be sealed by the microphone hole plug 17, which is shown in FIGS. 2 and 3. Further details of the microphone hole plug 17 and its internal plug extension 18 are shown in FIG. 44. The internal plug extension 18 of the microphone hole plug 17 fits inside the microphone hole 16 in order to seal the interior of the camera body 12 from debris and fluids such as water.

Any suitable type of microphone may be provided inside the camera body 12 near the microphone hole 16 to detect sound. One or more microphones may be used inside and/or outside the camera body 12. In addition to an internal microphone(s), at least one microphone may be mounted on the camera system 10 and/or positioned remotely from the system. In the event that multiple channels of audio data are recorded from a plurality of microphones in a known orientation, the audio field may be rotated during playback to synchronize spatially with the interactive renderer display. The microphone output may be stored in an audio buffer and compressed before being recorded. In the event that multiple channels of audio data are recorded from a plurality of microphones in a known orientation, the audio field may be rotated during playback to synchronize spatially with the corresponding portion of the video image.

As shown in FIGS. 8-10, the bottom 20 of the camera body 12 includes a mount attachment hole 21 that may be used to detachably mount the camera system 10 on various mounting devices, as more fully described below. The mount attachment hole 21 includes a wide mount attachment wall opening 22 and a narrow mount attachment wall opening 23. A first retaining tab 24 extends radially inward around a portion of the circumference of the mount attachment hole 21, and a second retaining tab 25 extends radially inward from another portion of the mount attachment hole 21. As shown in FIGS. 8 and 10, the first and second retaining tabs 24 and 25 define the wide and narrow mount attachment wall openings 22 and 23. As more fully described below, this structural configuration permits the camera system 10 to be detachably mounted with a pre-determined alignment on a mounting stud of various mounting assemblies.

As shown in FIGS. 8 and 9, a central reset button 26 may be provided inside the mount attachment hole 21. As shown in FIG. 8, power cradle alignment recesses 27 having generally semi-circular shapes are provided in order to aid in alignment of the camera system 10 when it is placed on a charging cradle 200, as more fully described below. In addition, two power cradle alignment magnets 29 are installed near the bottom 20 radially outside the mount attachment hole 21 to further aid in alignment of the camera system 10 when it is positioned on the charging cradle 200, as more fully described below. Several contact pins 28 are circumferentially spaced around the bottom 20 radially outside the mount attachment hole 21. As more fully described below, the contact pins 28 are used in conjunction with contact clips 220 of the charging cradle 200. The contact pins 28 may be made of any suitable electrically conductive material such as copper, aluminum, brass, stainless steel, gold, gold-plated stainless steel or the like.

FIG. 11 is a partially schematic side sectional view of a camera system 11 similar to the camera system 10 shown in FIGS. 3 and 9, with the addition of a heat sink 90 positioned around the processor support cage 61 and adjacent to the processor module 60. The heat sink 90 may be made of any suitable thermally conductive material, such as aluminum or the like. At least one mechanical fastener 92 may be used to secure the heat sink 90 within the camera body 12. The heat sink 90 may be used to transfer heat away from the processor module 60 and the battery 80 located therein. Heat generated by the battery 80, processor module 60 and any other components of the camera system 10 may therefore be transferred toward the camera body 12.

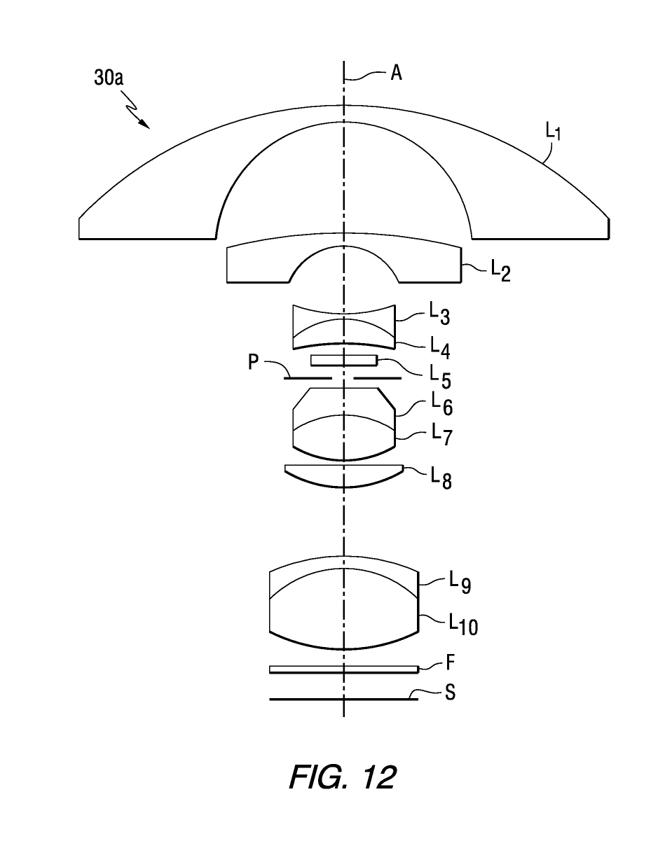

In accordance with embodiments of the present invention, the panoramic lens may comprise transmissive hyper-fisheye lenses with multiple transmissive elements (e.g., dioptric systems); reflective mirror systems (e.g., panoramic mirrors as disclosed in U.S. Pat. Nos. 6,856,472; 7,058,239; and 7,123,777, which are incorporated herein by reference); or catadioptric systems comprising combinations of transmissive lens(es) and mirror(s). In certain embodiments, the panoramic lens 30 comprises various types of transmissive dioptric hyper-fisheye lenses. Such lenses may have fields of view FOVs as described above, and may be designed with suitable F-stop speeds. F-stop speeds may typically range from f/1 to f/8, for example, from f/1.2 to f/3. As a particular example, the F-stop speed may be about f/2.5. Examples of panoramic lenses are schematically illustrated in FIGS. 12-15.

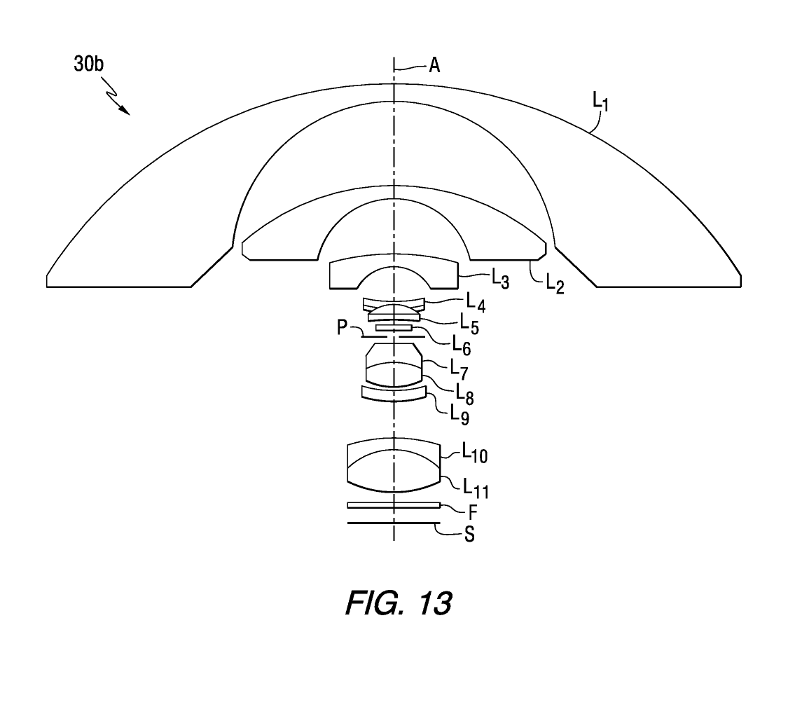

FIGS. 12 and 13 schematically illustrate panoramic lens systems 30a and 30b similar to those disclosed in U.S. Pat. No. 3,524,697, which is incorporated herein by reference. The panoramic lens 30a shown in FIG. 12 has a longitudinal axis A and comprises ten lens elements L₁-L₁₀. In addition, the panoramic lens system 30a includes a plate P with a central aperture, and may be used with a filter F and sensor S. The filter F may comprises any conventional filter(s), such as infrared (IR) filters and the like. The panoramic lens system 30b shown in FIG. 13 has a longitudinal axis A and comprises eleven lens elements L₁-L₁₁. In addition, the panoramic lens system 30b includes a plate P with a central aperture, and is used in conjunction with a filter F and sensor S.

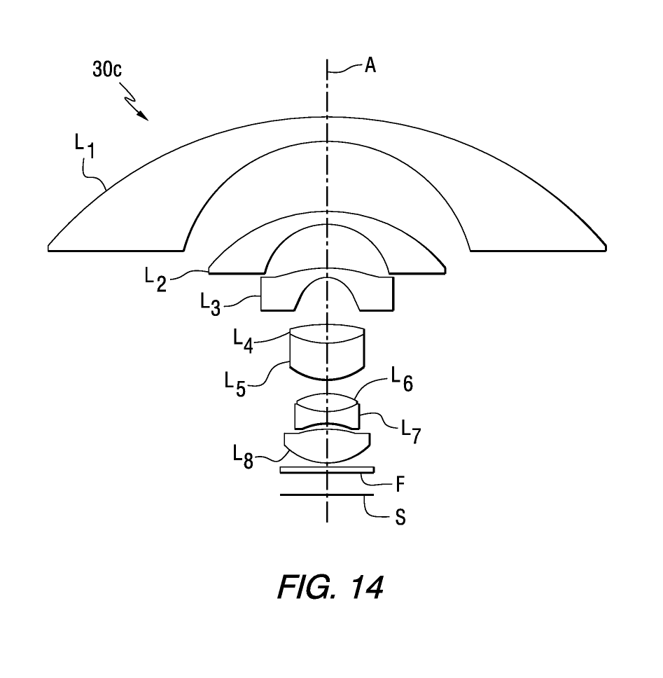

In the embodiment shown in FIG. 14, the panoramic lens assembly 30c has a longitudinal axis A and includes eight lens elements L₁-L₈. In addition, a filter F and sensor S may be used in conjunction with the panoramic lens assembly 30c.

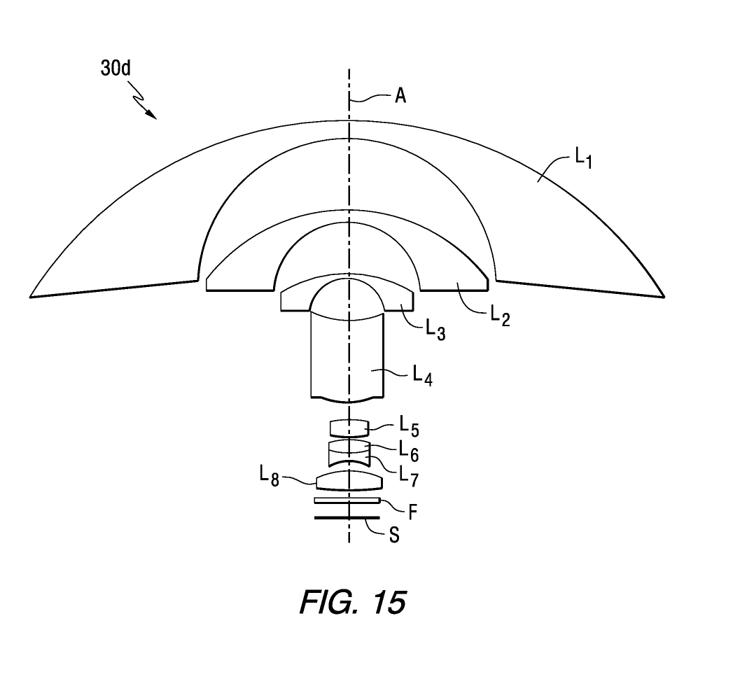

In the embodiment shown in FIG. 15, the panoramic lens assembly 30d has a longitudinal axis A and includes eight lens elements L₁-L₈. In addition, a filter F and sensor S may be used in conjunction with the panoramic lens assembly 30d.

In each of the panoramic lens assemblies 30a-30d shown in FIGS. 12-15, as well as any other type of panoramic lens assembly that may be selected for use in the camera system 10, the number and shapes of the individual lens elements L may be routinely selected by those skilled in the art. Furthermore, the lens elements L may be made from conventional lens materials such as glass and plastics known to those skilled in the art.

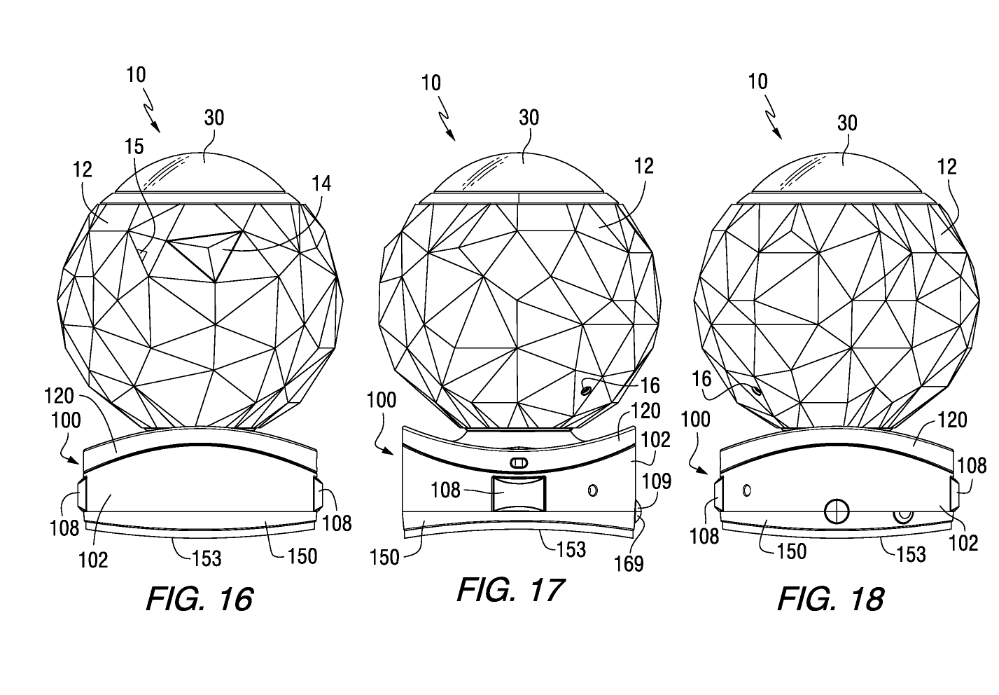

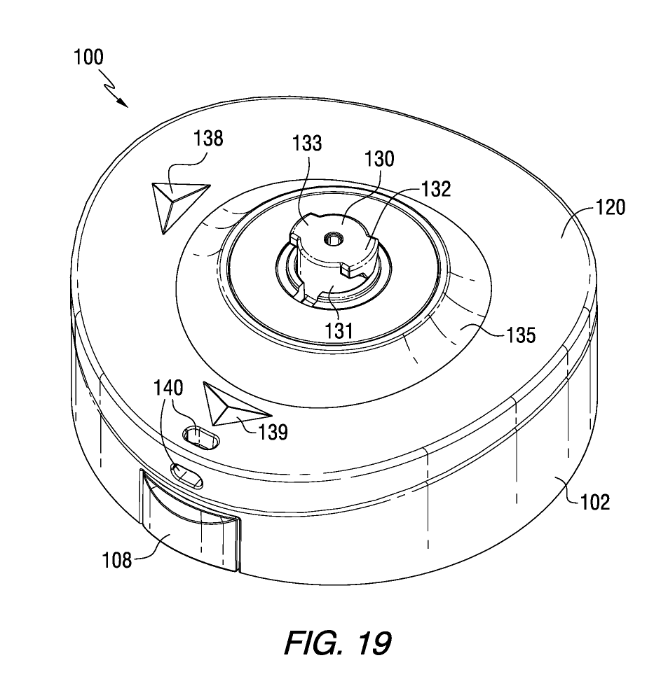

FIGS. 16-18 illustrate the camera system 10 mounted on a tilt mount assembly 100 in accordance with an embodiment of the present invention. FIGS. 19-29 illustrate various features of the tilt mount assembly 100. The tilt mount assembly 100 includes a lower base 102 to which an upper mounting plate 120 is attached. The lower base 102 includes a cylindrical sidewall 103, substantially flat bottom 104 and curved top surface 105. The lower base 102 and upper mounting plate 120 may be made of any suitable materials, such as reinforced thermoplastic or the like. Spring-loaded mounting buttons 108 with retaining notches 107 are retractably mounted in the sidewall 103 of the lower base 102. As more fully described below, the tilt mount assembly 100 may be detachably mounted on a baseplate 150, e.g., as shown in FIGS. 16-18.

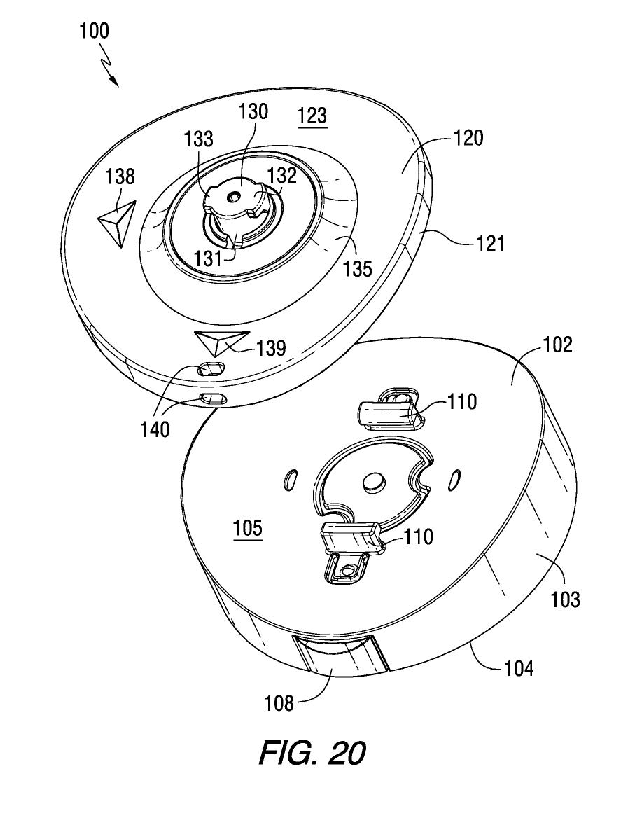

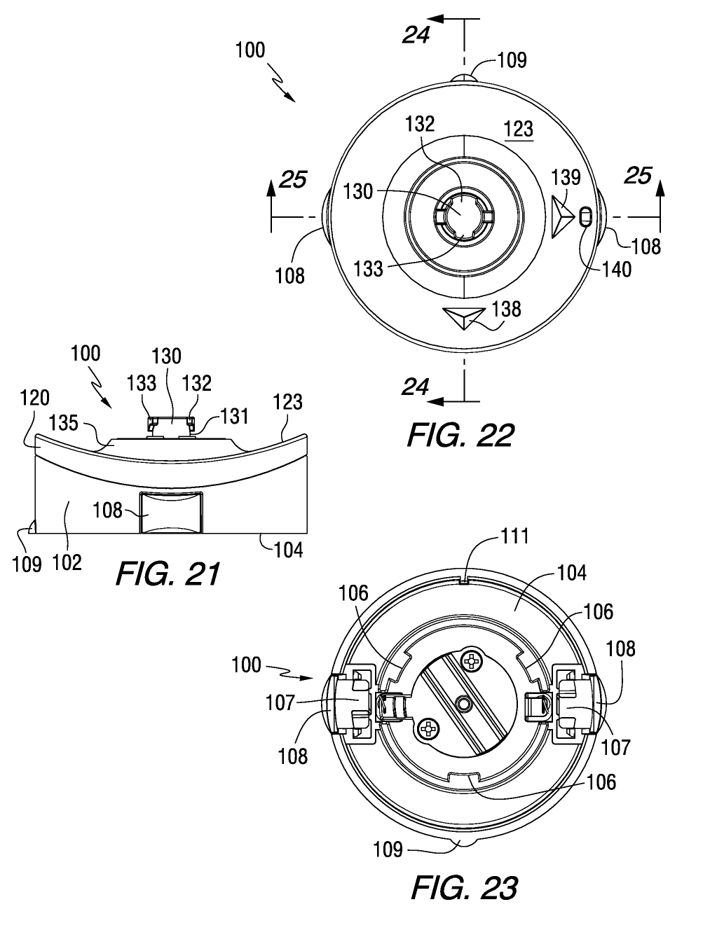

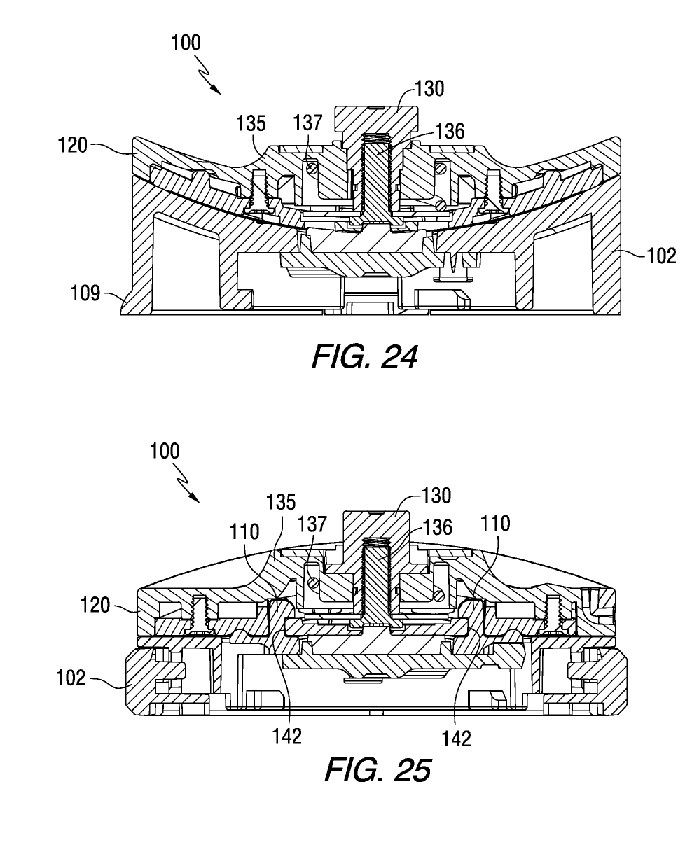

FIG. 19 is an isometric view of the tilt mount assembly 100 and FIG. 20 is an exploded isometric view thereof. FIG. 21 is a side view, FIG. 22 is a top view and FIG. 23 is a bottom view of the tilt mount assembly 100. FIG. 24 is a side sectional view taken from section 24-24 of FIG. 22. FIG. 25 is another side sectional view taken from section 25-25 of FIG. 22. As shown in these figures, the upper mounting plate 120 of the tilt mount assembly 100 includes a mounting stud 130 comprising a central cylindrical peg 132, a relatively large cammed retention nub 132, and a relatively small cammed retention nub 133. The underside of each retention nub 132 and 133 includes a ramped cam surface that engages a corresponding retaining tab 24 and 25 of the mount attachment hole 21 when the camera system 10 is mounted on the tilt mount assembly 100, or when the camera system 10 is mounted on similar mounting studs of other mount assemblies described below. The mounting stud 130 is configured to engage with the mount attachment hole 21 of the camera system 10 in order to detachably mount the camera system 10 on the tilt mount assembly 100 in a specified orientation. The mounting stud 130 may be made of any suitable material such as metal or plastic, e.g., stainless steel. The upper mounting plate 120 includes a raised mounting stage 135 upon which the bottom 20 of the camera system 10 may be supported. As shown in FIGS. 19 and 20, the mounting stud 130 is located at the center of the raised mounting stage 135 and extends axially outward therefrom. A front indicator marking 138 and side indicator marking 139 are provided in order to aid in mounting of the camera system 10 on the tilt mount assembly 100 in the desired orientation. A lanyard hole 140 extends through the upper mounting plate 120, and may be used to receive a lanyard (not shown) that can be used to carry or secure the tilt mount assembly 100.

As shown most clearly in FIGS. 24 and 25, the mounting stud 130 is threadingly secured to a threaded stud bolt 136. The mounting stud 130 and stud bolt 136 are movable in a vertical direction a slight distance within the upper mounting plate 120. A spring 137 is provided inside the raised mounting stage 135. The spring 137 presses downward against a washer surrounding the stud bolt 136 to thereby bias the stud bolt 136 and mounting stud 130 to their lowermost retracted positions as shown in FIGS. 24 and 25. When the camera system 10 is mounted on the tilt mount assembly 100 by a quarter-twist rotational movement described below, the mount attachment hole 21 of the camera system 10 engages the mounting stud 130 and draws the mounting stud 130 axially outward from the raised mounting stage 135 against the bias of the spring 137. The movement of the mounting stud 130 from its retracted position to its extended position is caused by engagement between ramped cam surfaces on the undersides of the cammed retention nubs 132 and 133, and cam surfaces on the interior sides of the first and second retaining tabs 24 and 25. During installation, the camera system 10 is initially moved axially toward the tilt mount assembly 100 in a rotational orientation in which the retention nubs 132 and 133 are offset from the retaining tabs 24 and 25. Once the mounting stud 130 is axially inserted in the mount attachment hole 21, the camera system is rotated 90° into its locked position. The mounting stud 130 and mount attachment hole 21 are configured to provide a mechanical stop position beyond which the camera system 10 cannot rotate. When the camera system is rotated by the 90° or quarter-twist movement to its locked position, the spring 137 may provide frictional force between the cammed retention nubs 132 and 133, and the first and second retaining tabs 24 and 25, which helps secure the camera system in its locked position. In order to unlock the camera system 10, sufficient rotational force must be applied in order to overcome such frictional force.

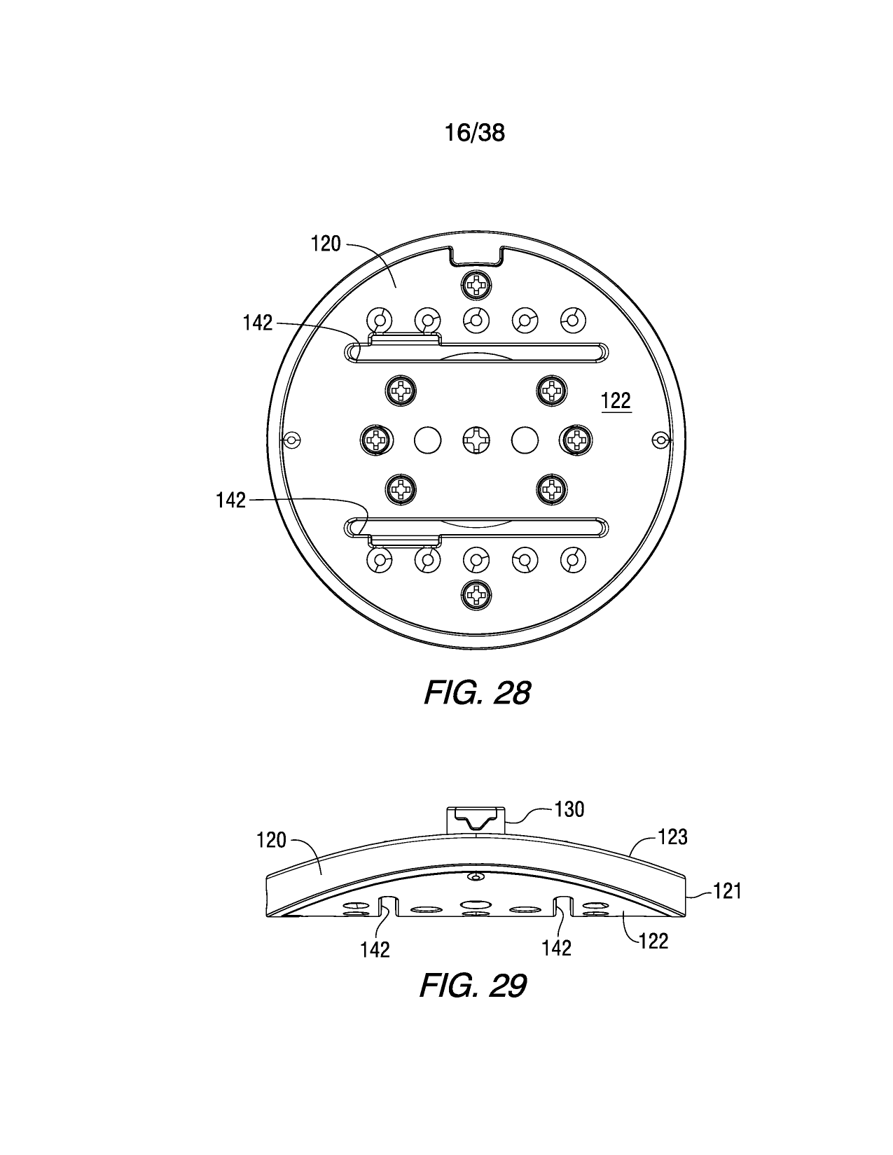

As shown in FIG. 20, the lower base 102 of the tilt mount assembly 100 includes support clips 110 extending axially upward from the curved top surface 105 of the lower base 102. Each of the support clips 110 includes a radially inwardly extending upper lip. As shown in the side sectional view of FIG. 25, each of the support clips 110 extends through a retaining slot 142 of the upper mounting plate 120. The retaining slots 142 of the upper mounting plate 120 are also shown in FIGS. 28 and 29. When the support clips 110 are engaged within the retaining slots 142 as shown in FIG. 25, the upper mounting plate 120 may be permanently mounted on the lower base 102, and is slidable to various tilt positions, as more fully described below. As shown in FIGS. 21-24, 26 and 27, an alignment nub 109 extends radially outward from the peripheral surface of the lower base 102. The alignment nub 109 may aid in the alignment of the tilt mount assembly 100 on baseplates 150 and 250, as more fully described below. FIG. 17 illustrates the alignment of the alignment nub 109 with a corresponding alignment nub 169 located on a baseplate 150.

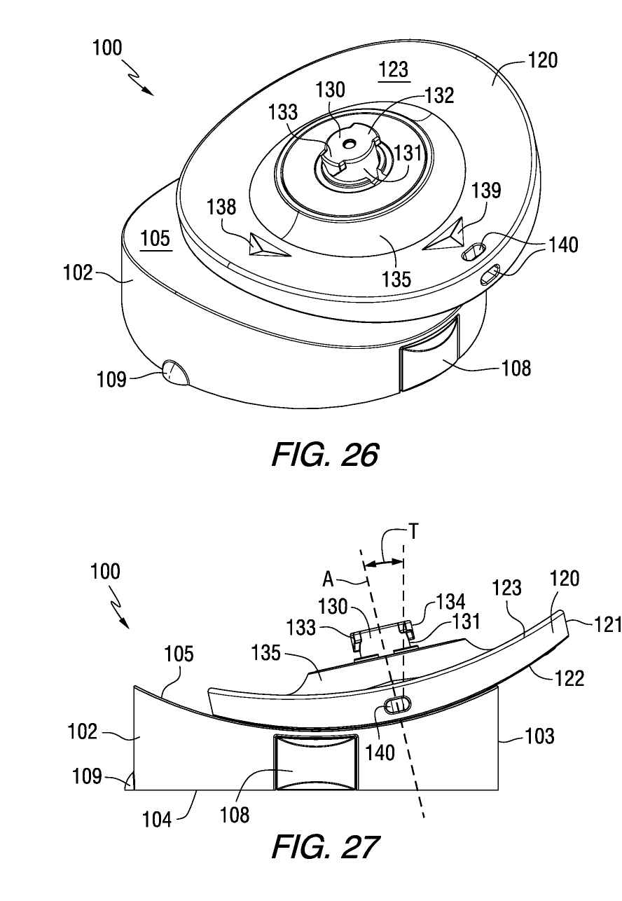

FIGS. 26 and 27 illustrate a tilt function of the tilt mount assembly 100 in accordance with an embodiment of the present invention. FIGS. 26 and 27 illustrate the upper mounting plate 120 in a tilted position with respect to the lower base 102, as compared to their vertically aligned positions shown in FIG. 21. While the axis A of the mounting stud 130 corresponds to the longitudinal axis A of the panoramic lens 30, the upper mounting plate 120 as shown in FIG. 27 has been moved to a tilt angle T in which the longitudinal axis A is oriented at an angle with respect to a vertical axis. The ability to provide the tilt angle T enables the camera system 10 to capture panoramic visual images, such as panoramic videos, at multiple adjustable angles.

FIGS. 28 and 29 illustrate the retaining slots 142 of the upper mounting plate 120 in which the support clips 110 of the lower base 102 are slidingly received. When the upper mounting plate 120 is moved from its aligned position as shown in FIG. 21 to its tilted position as shown in FIG. 27, the support clips 110 slide within the retaining slots 142 in order to enable the upper mounting plate 120 to move to various tilt angles T. The tilt angle T may be selected as desired. For example, the tilt angle T may be at least ±5°, or at least ±10°. For example, the tilt angle T may range from ±10° to ±45°, or from ±15° to ±30°. In accordance with certain embodiments, the tilt angle T may be infinitely adjustable within the tilt angle ranges, or may be incrementally adjusted at selected angles, e.g., in increments of 1°, 2°, etc. by means of any suitable détente mechanism or the like.

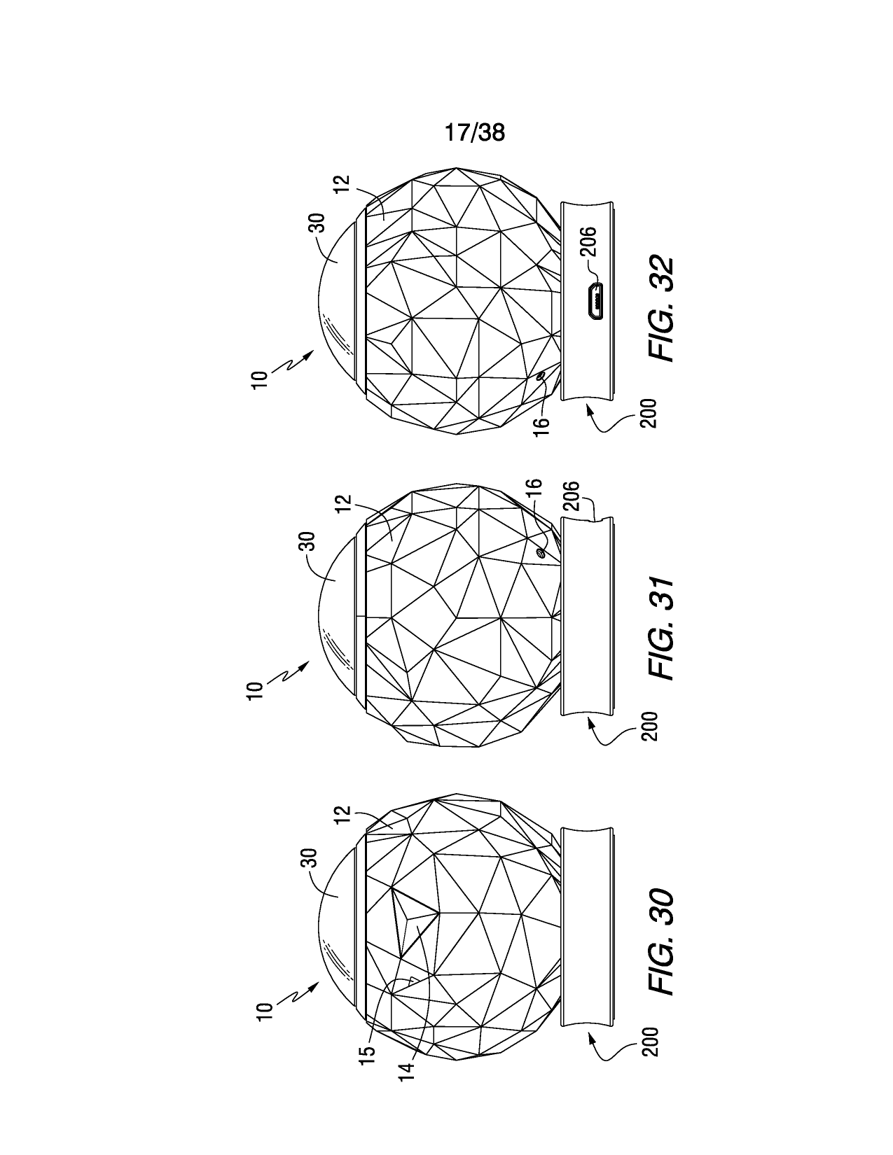

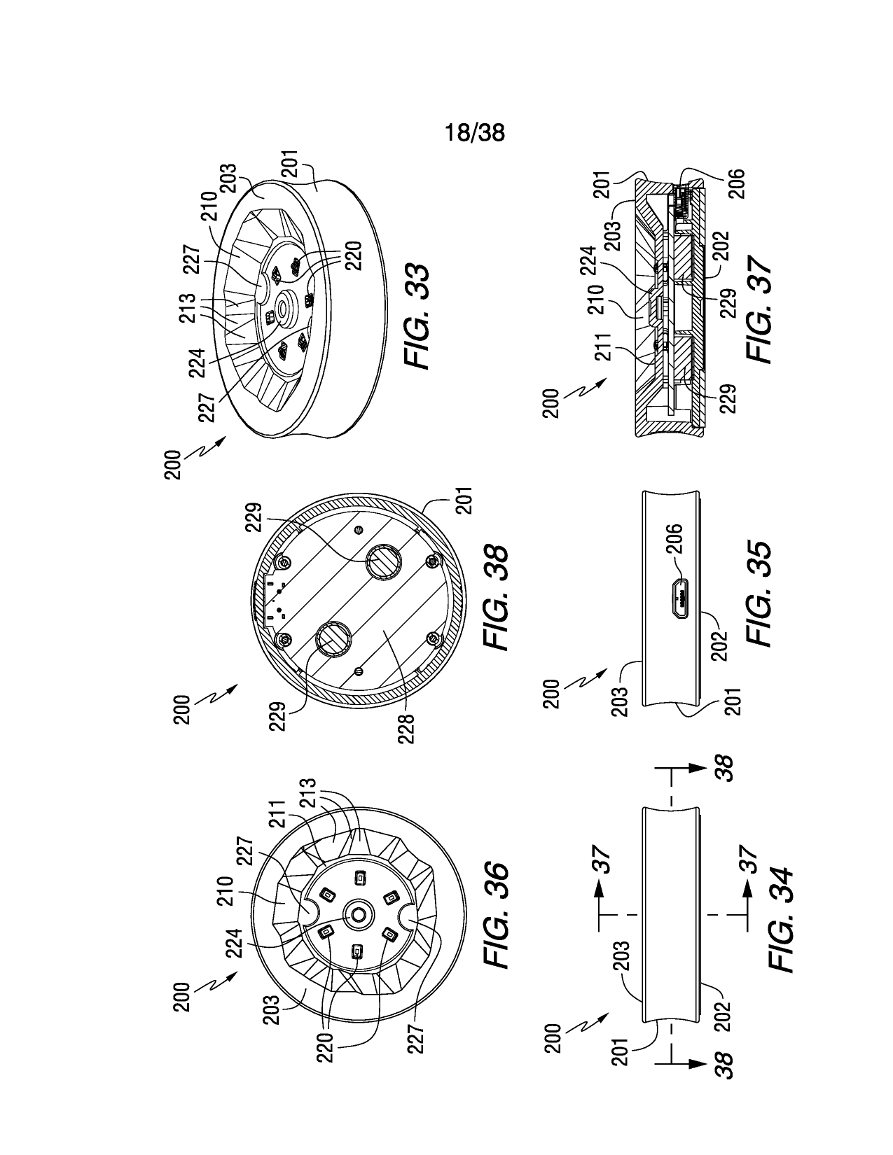

FIGS. 30-32 illustrate the camera system 10 positioned on a charging cradle 200 in accordance with an embodiment of the present invention. FIGS. 33-38 illustrate various features of the charging cradle 200. FIG. 33 is an isometric view, FIG. 34 is a front view, FIG. 35 is a rear view and FIG. 36 is a top view of the charging cradle 200. FIG. 37 is a side sectional view taken from section 37-37 of FIG. 34. FIG. 38 is a top cross-sectional view taken from section 38-38 of FIG. 34. As shown in the figures, the charging cradle 200 includes a generally cylindrical sidewall 201 having a slightly concave curved shape. The charging cradle 200 also includes a bottom surface 202 and top surface 203. A USB/power port 206 is provided through the sidewall 201. As shown most clearly in FIGS. 33, 36 and 37, the charging cradle 200 includes a recessed nest 210 extending vertically downward from the top surface 203 radially inside the sidewall 201. A bottom floor 211 is provided at the bottom of the recessed nest 210. In the embodiment shown, the recessed nest 210 includes multiple facets 213 extending downward and radially inward from the top surface 203 to the bottom floor 211. Each facet 213 comprises a generally planar face, and the planes of adjacent facets are slightly offset with respect to each other. In certain embodiments, the pattern of the facets 213 matches a corresponding pattern of the facets 13 of the camera body 12. For example, the facets 213 of the charging cradle 200 may match the facets 13 of the camera body 12 such that the facets are only aligned when the camera system 10 is in a particular rotational orientation with respect to the charging cradle 200. While a faceted surface 213 is shown in the figures, it is to be understood that any other suitable surface shapes may be used, e.g., to match a particular surface shape of a particular camera system. For example, the surface of the recessed nest 210 may alternatively be conical, spherical, cylindrical or the like.

As further shown in FIGS. 33, 36 and 37, the charging cradle 200 includes multiple contact clips 220 that are arranged at the bottom of the recessed nest 210 to match the corresponding locations of the contact pins 28 on the bottom 20 of the camera system 10. The contact clips 220 may be made of any suitable electrically conductive material such as copper, aluminum, brass, stainless steel, gold, gold-plated stainless steel or the like, and may be resilient and/or spring loaded in order to ensure contact with the contact pins 28 when the camera system 10 is mounted in the charging cradle 200.

As shown in FIGS. 33, 36 and 37, a central pin 224 is located at the bottom of the recessed nest 210. The central pin 224 is slightly raised above the bottom surface of the recessed nest 210 and has an outer diameter slightly less than or equal to an inside diameter of the mount attachment hole 21 of the camera system 10, as measured radially between the first and second retaining tabs 24 and 25. Thus, when the camera system 10 is placed in the charging cradle 200, insertion of the central pin 224 into the mount attachment hole 21 helps to align the camera system in its desired nesting position. The camera system 10 is further mechanically aligned within the charging cradle 200 by the provision of a pair of raised alignment tabs 227 at the bottom of the charging cradle 200 that fit within the corresponding pair of power cradle alignment recesses 27 at the bottom 20 of the camera body, as shown in FIG. 8.

In addition to these mechanical alignment features, the camera system 10 may be magnetically aligned in the charging cradle 200 by the provision of magnets 229 located at or below the bottom floor 211 of the recessed nest 210. Such alignment magnets 229 are most clearly shown in FIGS. 37 and 38. Each alignment magnet 229 may comprise a permanent magnet with its north pole pointing up or down. The corresponding power cradle alignment magnets 29 of the camera system 10 may also be permanent magnets with their north poles pointing up or down. When the camera system 10 is in the desired rotational orientation with respect to the charging cradle 200, one of the alignment magnets 29 contained in the bottom of the camera body is oriented with its north pole facing downward, with the corresponding alignment magnet 229 of the charging cradle 200 having its south pole facing upward. The remaining alignment magnet 29 of the camera system and the remaining corresponding alignment magnet 229 of the charging cradle 200 are oriented with their poles in opposite directions. In this manner, the permanent magnets force the camera system 10 to be rotated into a single, pre-selected rotational orientation with respect to the charging cradle 200. If the camera system 10 is initially placed in the charging cradle 200 in a rotational position other than the desired orientation, the alignment magnets 29 and 229 will act to rotate the camera system 10 into the proper orientation. While the camera system 10 may be held within the charging cradle 200 by the force of gravity, the magnetic forces between the alignment magnets 29 of the camera system and alignment magnets 229 of the charging cradle further help to secure the camera system 10 within the charging cradle 200.

In addition to such magnetic alignment and securement, the interaction between the alignment tabs 227 of the charging cradle and the alignment recesses 27 of the camera system, along with the interaction between the central pin 224 of the charging cradle 200 and the mount attachment hole 21 of the camera system, provide for mechanical alignment of the camera system 10 with respect to the charging cradle 200. The camera system 10 is thus not only secured within the charging cradle 200, but is secured in the desired rotational orientation in which the contact pins 28 of the camera system are aligned with the contact clips 220 of the charging cradle in order to provide electrical contact between the camera system and charging cradle. While the charging cradle 200 relies on gravitational and magnetic forces to secure the camera system 10 in the charging cradle 200, it is to be understood that any other suitable securement means may be used. For example, the charging cradle 200 may be provided with a central mounting stud (not shown) that is identical or similar to the mounting stud 130 of the tilt mount assembly 100.

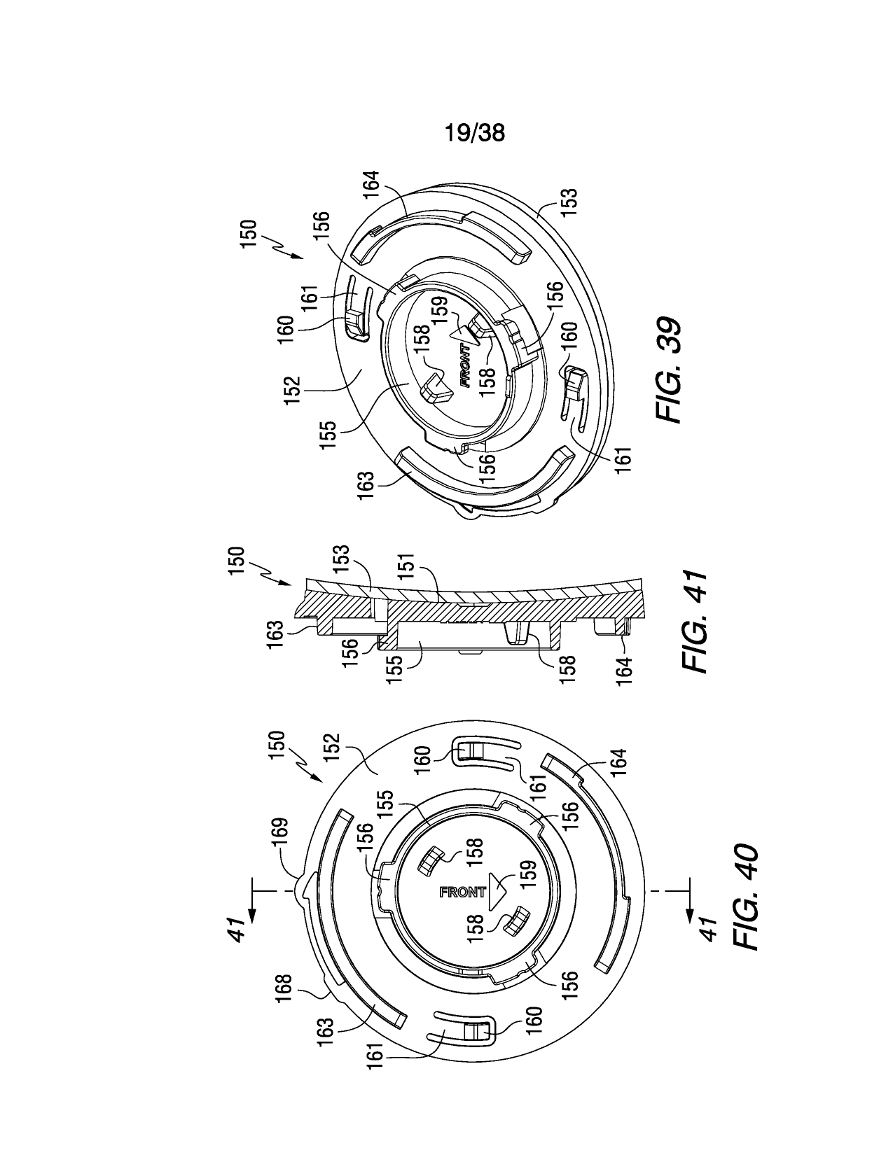

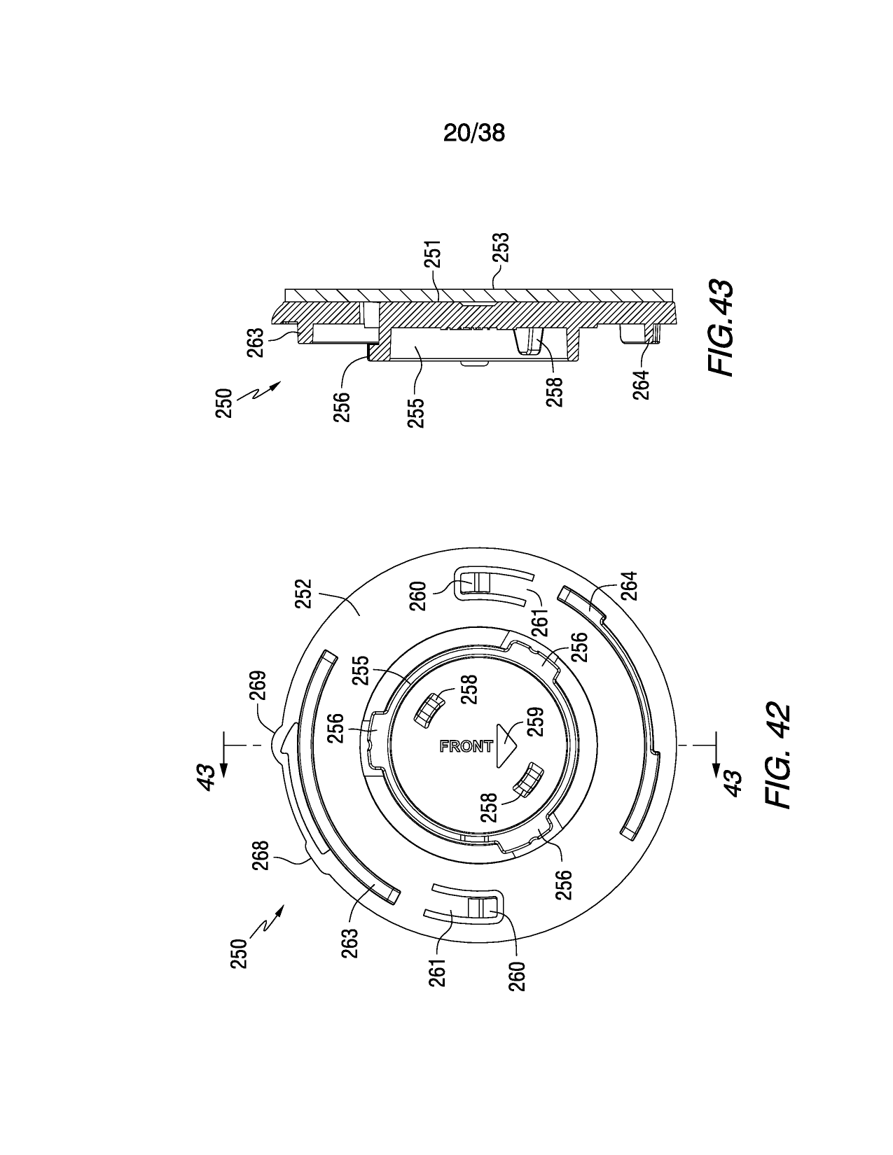

FIGS. 39-43 illustrate further features of baseplates in accordance with embodiments of the present invention. FIGS. 39-40 illustrate a curved baseplate 150. FIGS. 42 and 43 illustrate a flat baseplate 250. The baseplates 150 and 250 may be made of any suitable materials, such as conventional plastics or the like.

As shown in FIGS. 39-40, the curved baseplate 150 includes a curved rear surface 151 and a front face 152. A rear contact pad 153 covers at least a portion of the curved rear surface 151. The rear contact pad 153 may be made of a relatively thick layer of resilient material, and may have an adhesive applied to the outer rear surface thereof. A layer of conventional release material (not shown) may be used to cover the adhesive on the rear contact pad 153. The release layer may be removed when the baseplate 150 is installed on a desired support surface, such as a helmet, surfboard or other curved surface.

The baseplate 150 includes a raised annular ring 155 having mounting tabs 156 extending radially outward therefrom. In the embodiment shown, three mounting tabs 156 are equally spaced around the circumference of the raised annular ring 155. As shown in FIGS. 39 and 41, each mounting tab 156 includes an end wall extending axially downward therefrom along the exterior surface of the raised annular ring 155. Support pillars 158 located radially inside the raised annular ring 155 extend axially from the front surface 152 of the baseplate 150. An alignment arrow 159 is provided on the front surface 152. As shown most clearly in FIGS. 39 and 40, rotational retention tabs 160 are located at the ends of flexible spring arms 161. The rotational retention tabs 160 extend upward from the front surface 152, but can be retracted toward the plane of the front surface by flexing the spring arms 161. A solid annular guide rail 163 extends upward from the front surface 152, and a circumferentially spaced notched annular guide rail 164 also extends from the front surface 152. The baseplate 150 includes a flattened alignment nub 168 extending radially outwardly therefrom, and a circumferentially offset rounded alignment nub 169 extending radially outward therefrom. The flattened alignment nub 168 is intended to mark an initial unlocked position of the tilt mount assembly 100, while the rounded alignment nub 169 is intended to mark a locked position of the tilt mount assembly 100 when it is mounted on the baseplate 150.

The baseplate 150 is structured and arranged to releasably secure the tilt mount assembly 100 thereon. As shown in FIG. 23, the bottom 104 of the tilt mount assembly 100 includes an annular flange with radially inwardly extending tabs 106 circumferentially spaced around the inner diameter of the flange. The radial tabs 106 of the tilt mount assembly 100 define radial inner diameters greater than the outer diameter of the raised annular ring 155 of the baseplate 150. During installation of the tilt mount assembly 100 onto the baseplate 150, the tilt mount assembly 100 may be axially moved into its mounting position as long as the radially mounting tabs 106 of the tilt mount assembly 100 are not circumferentially aligned with the radially outwardly extending mounting tabs 156 of the baseplate 150. However, once the tilt mount assembly radial tabs 106 are moved axially past the baseplate mounting tabs 156, rotation of the tilt mount assembly with respect to the baseplate 150 causes the radial tabs 106 and mounting tabs 156 to be circumferentially aligned and engaged with each other, thereby preventing the tilt mount assembly 100 from being axially removed from the baseplate 150.

When the tilt mount assembly 100 is secured in its locked position on the baseplate 150, the rotational retention tabs 160 of the baseplate 150 engage in the retaining notches 107 of each retractable mounting button 108. During installation, the rotational retention tabs 160 of the baseplate 150 move into their respective retention notches 107 of the tilt mount assembly 100. This can occur when the tilt mount assembly 100 is rotated into its locked position in the baseplate 150 because the flexible spring arms 161 allow the retention tabs 160 to axially retract when they engage ramped outer surfaces of each retaining notch 107. Once each retention tab 160 is rotated into position in its respective retaining notch 107, the spring arm 161 biases the retainer tab in its engaged position within the retaining notch 107.

To disengage the tilt mount assembly 100 from the baseplate 150, the retractable mounting buttons 108 are pressed radially inward against their spring bias to positions where the rotational retention tabs 160 of the baseplate 150 are no longer retained within the retaining notches 107 of the tilt mount assembly. With the retractable mounting buttons 108 pressed inward, the tilt mount assembly 100 is free to rotate from its locked position to a circumferential position in which the radial tabs 106 and mounting tabs 156 are no longer aligned, thereby allowing the tilt mount assembly 100 to be removed in an axial direction from the baseplate 150.

The flat baseplate 250 shown in the embodiment of FIGS. 42 and 43 includes similar features as the curved baseplate 105, with the exceptions that the flat baseplate 250 has a flat rear surface 251 and a flat rear contact pad 253. The baseplate 250 includes a raised annular ring 255 having mounting tabs 256 extending radially outward therefrom. In the embodiment shown, three mounting tabs 256 are equally spaced around the circumference of the raised annular ring 255. As shown in FIGS. 39 and 41, each mounting tab 256 includes an end wall extending axially downward therefrom along the exterior surface of the raised annular ring 255. Support pillars 258 located radially inside the raised annular ring 255 extend axially from the front surface 252 of the baseplate 250. An alignment arrow 259 is provided on the front surface 252. As shown most clearly in FIGS. 39 and 40, rotational retention tabs 260 are located at the ends of flexible spring arms 261. The rotational retention tabs 260 extend upward from the front surface 252, but can be retracted toward the plane of the front surface by flexing the spring arms 261. A solid annular guide rail 263 extends upward from the front surface 252, and a circumferentially spaced notched annular guide rail 264 also extends from the front surface 252. The baseplate 250 includes a flattened alignment nub 268 extending radially outwardly therefrom, and a circumferentially offset rounded alignment nub 269 extending radially outward therefrom. The flattened alignment nub 268 is intended to mark an initial unlocked position of the tilt mount assembly 200, while the rounded alignment nub 269 is intended to mark a locked position of the tilt mount assembly 200 when it is mounted on the baseplate 250. The flat baseplate 250 may be mounted on the tilt mount assembly 100 in a similar manner as the curved baseplate 150.

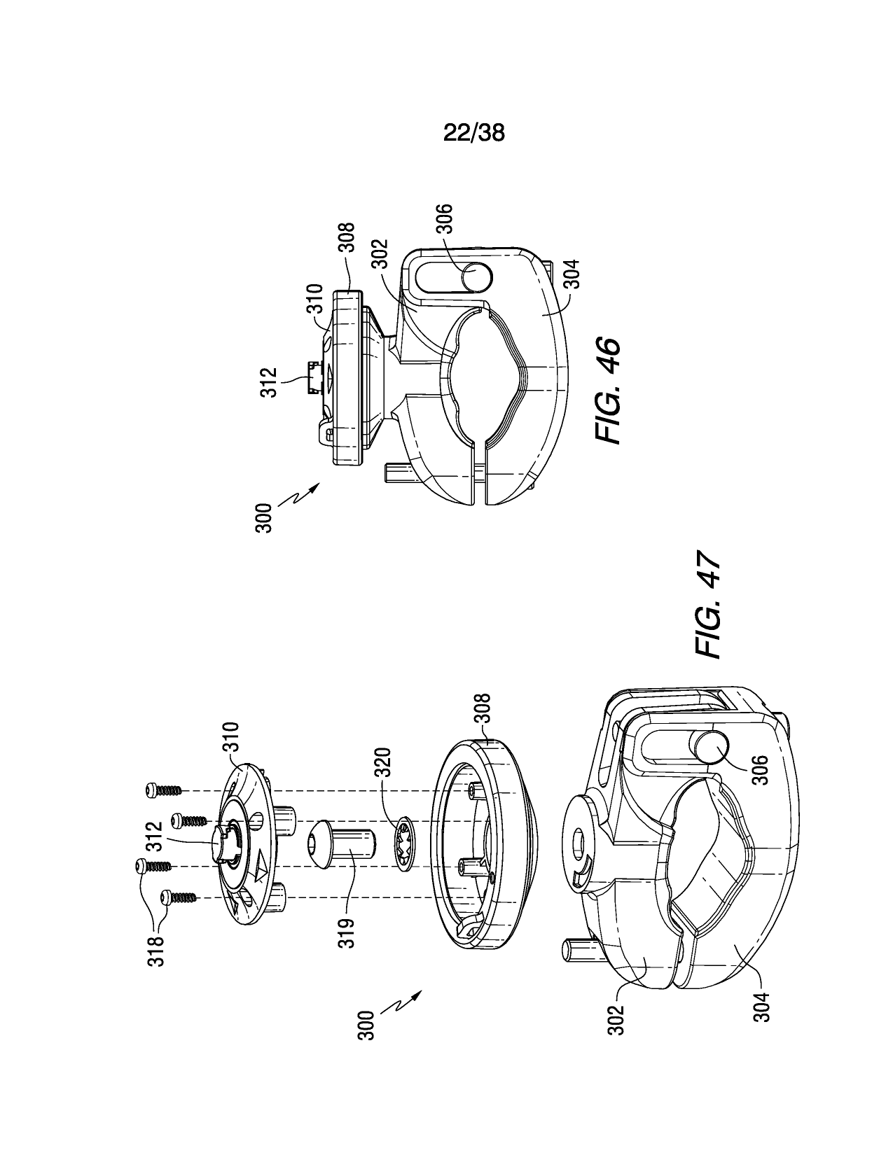

FIGS. 45-57 illustrate various types of mounting hardware that may be used with the camera system 10 in accordance with embodiments of the present invention.

FIGS. 45-47 illustrate a c-clamp mount assembly 300 in accordance with an embodiment of the present invention. The c-clamp mount assembly 300 includes an upper c-clamp arm 302 and a lower c-clamp arm 304 pivotally mounted with respect to each other by an adjustable pivot pin 306. A mounting base receiver 308 is attached to the upper c-clamp arm 302. A mounting base 310 is attached to the receiver 308. The mounting base 310 includes a mounting stud 312, which may have the same configuration as the mounting stud 130 described hereinabove. The camera system 10 may be attached to the mounting stud 312 of the c-clamp mount assembly 300 in the same manner as described above for attachment of the camera system 10 to the mounting stud 130 of the tilt mount assembly 100. As shown in the exploded assembly drawing of FIG. 47, the mounting base 310 and mounting stud 312 may be attached to the receiver 308 by means of multiple attachment screws 318. The receiver 308 may be attached to the upper c-clamp arm 302 by means of a central screw 319 and lock washer 320.

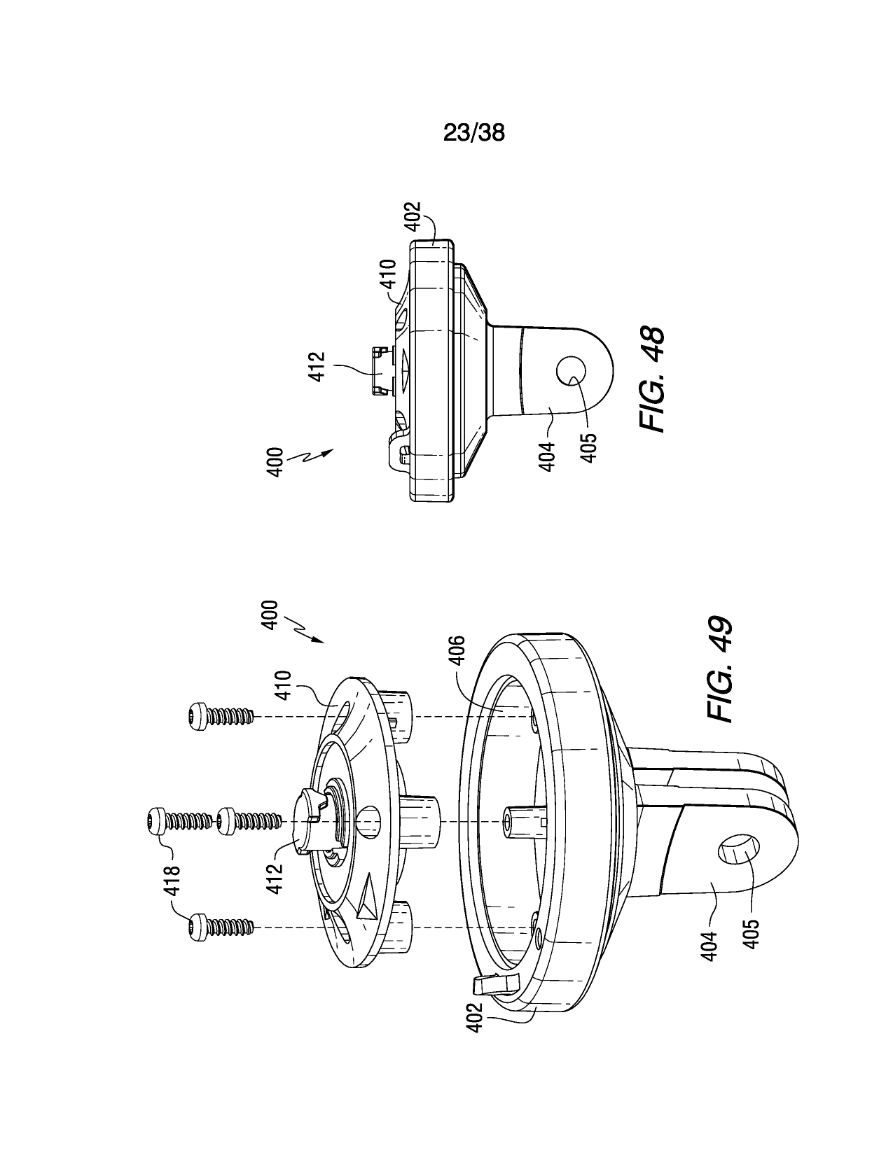

FIGS. 48 and 49 illustrate an action camera adapter mount assembly 400 in accordance with an embodiment of the present invention. The action camera adapter 400 includes a mounting base receiver 402 with mounting fingers 404 extending rearwardly therefrom. A connecting hole 405 is provided through the mounting fingers 404. The receiver 402 includes a central recess 406 in which a mounting base 410 may be installed. The mounting base 410 includes a mounting stud 412 identical or similar to the mounting stud 130 previously described hereinabove. The mounting base 410 and mounting stud 412 may be secured to the receiver 402 by means of attachment screws 418.

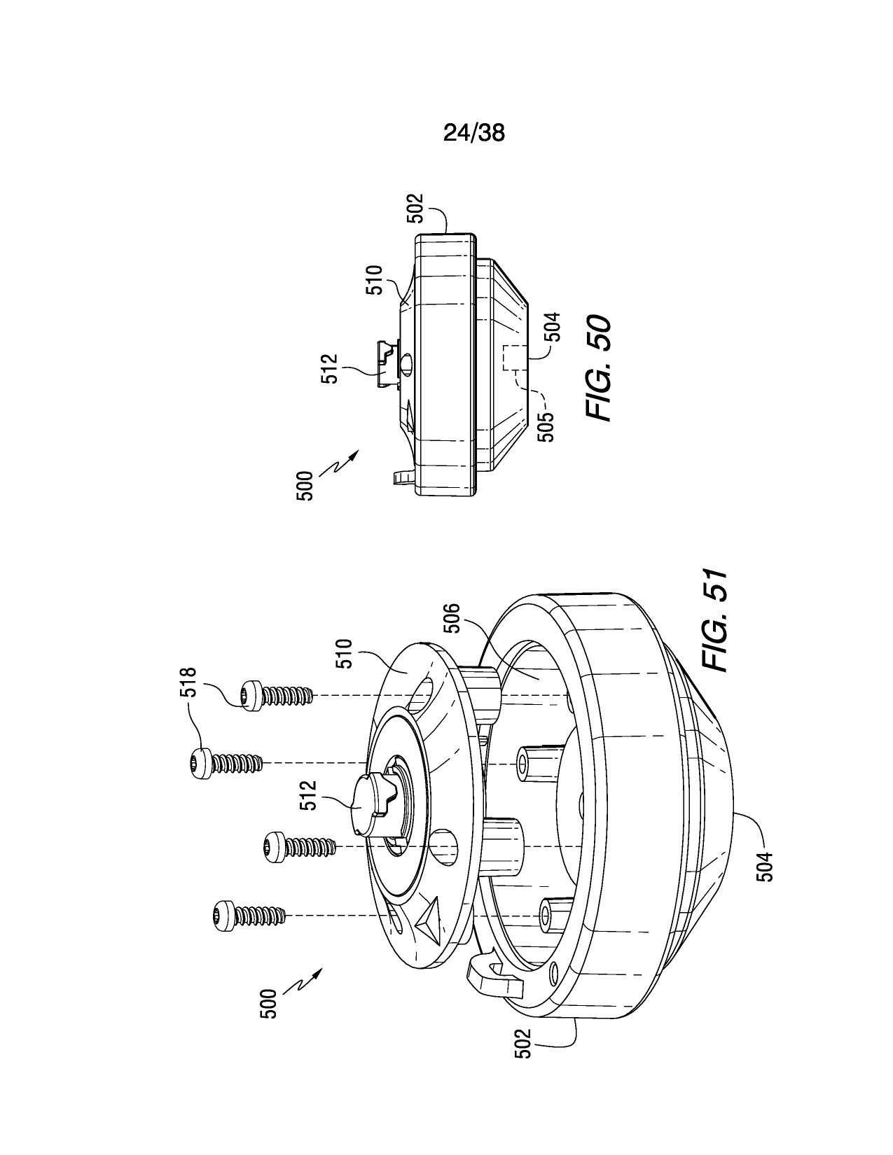

FIGS. 50 and 51 illustrate a tripod adapter mount assembly 500 in accordance with an embodiment of the present invention. The tripod adapter 500 includes an adapter body 502 with a bottom surface 504. As shown in FIG. 50, a threaded hole 505 is provided in the bottom surface 504. The threaded hole 505 may be of standard design for mounting on a threaded shaft (not shown) of a conventional camera tripod or the like. As understood by those skilled in the art, camera equipment may be secured to a conventional tripod or similar equipment by screwing a threaded bolt of the tripod into a threaded hole of the camera. The adapter body 502 includes a central recess 506 which receives a mounting base 510 having a mounting stud 512. The mounting stud 512 may be identical or similar to the previously described mounting stud 130. Multiple attachment screws 518 may be used to attach the mounting base 510 and mounting stud 512 to the adapter body 502.

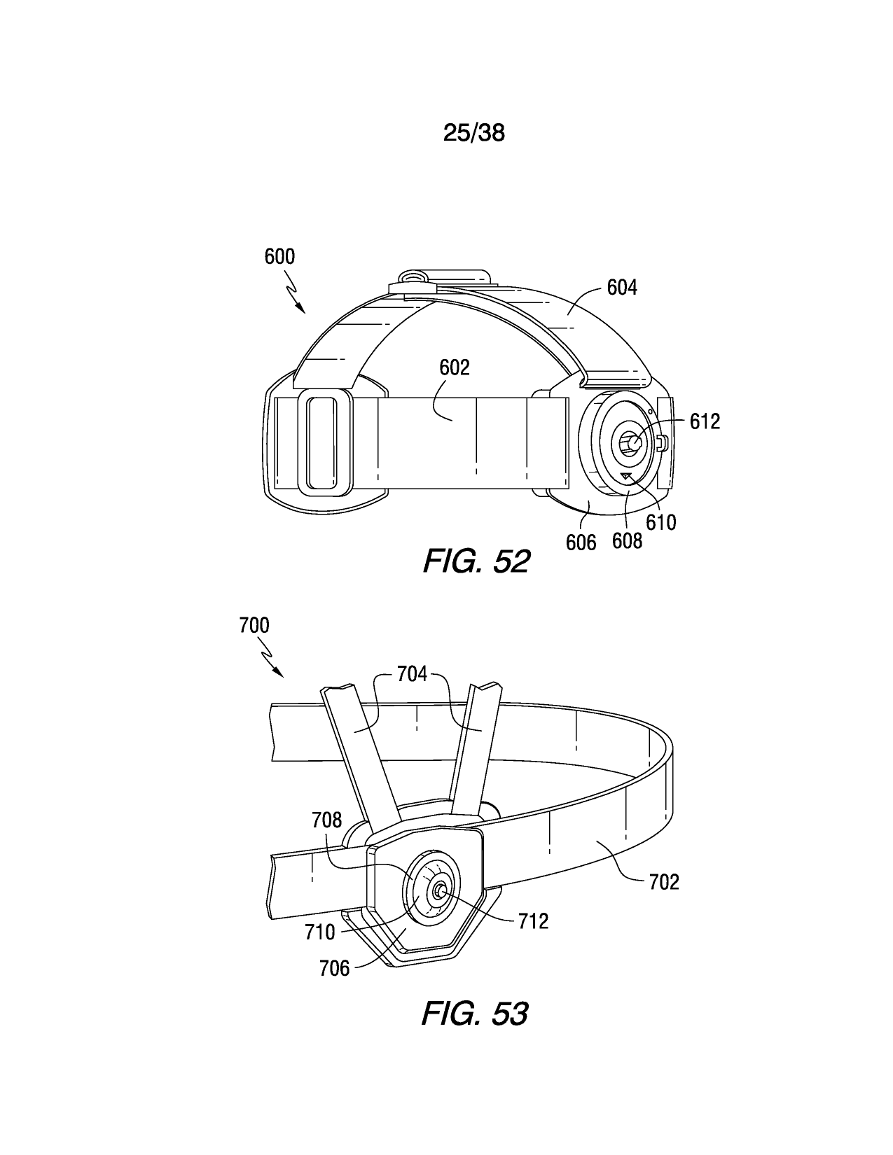

FIG. 52 illustrates a head mount assembly 600 in accordance with an embodiment of the present invention. The head mount assembly 600 includes a headband 602 and head strap 604, which in the embodiment shown may be adjustable. A mounting plate 606 is secured to the headband 602 and head strap 604. A receiver 608 is connected to the mounting plate 606. A mounting base 610 with a mounting stud 612 is attached to the receiver 608. The mounting base 610 may be similar to the previously described mounting bases 310, 410 and 510. The mounting stud 610 may be identical or similar to the previously described mounting stud 130. The head mount assembly 600 thus permits a camera system 10 to be mounted on the head of a user.

FIG. 53 illustrates a body mount assembly 700 in accordance with an embodiment of the present invention. The body mount assembly 700 includes a chest band 702 and support straps 704. A mounting plate 706 is attached to the chest band 702. A receiver 708 is attached to the mounting plate. A mounting base 710 and mounting stud 712 are connected to the receiver 708. The mounting base 710 may be similar to the mounting bases 310, 410, 510 and 610 described above. The mounting stud 712 may be identical or similar to the previously described mounting stud 130. The body mount assembly 700 is configured to be worn around the chest or other body part of a user.

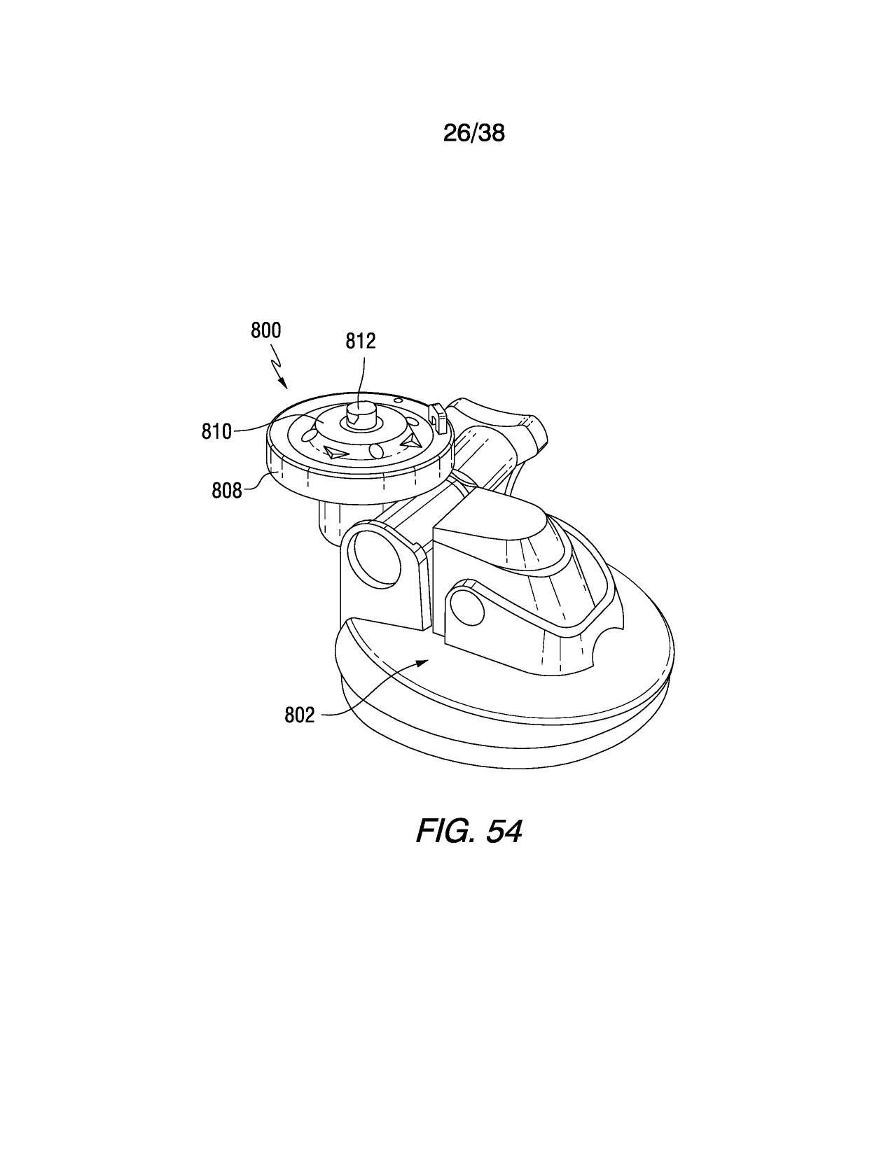

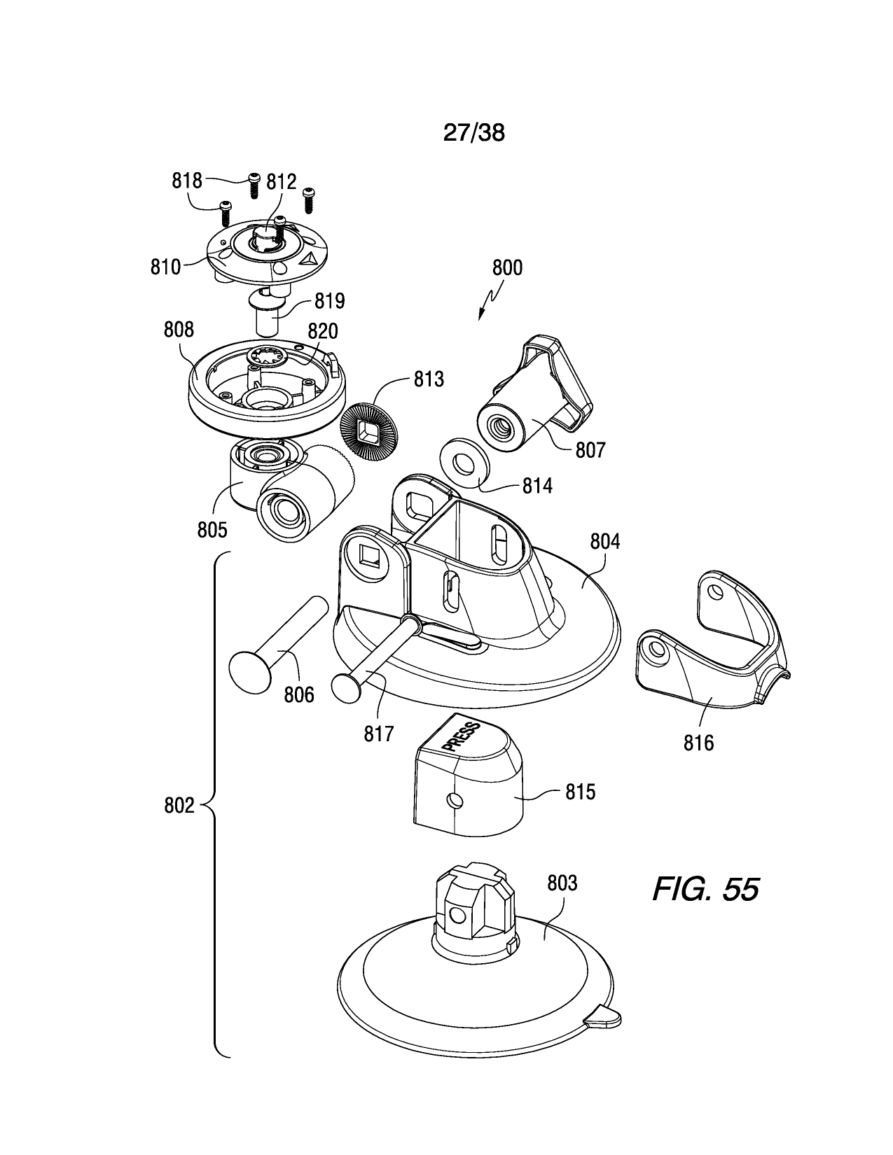

FIGS. 54 and 55 illustrate a suction assembly 800 in accordance with an embodiment of the present invention. The suction mount assembly 800 includes a suction base assembly 802 with a receiver 808 pivotally mounted thereon. A mounting base 810 is connected to the receiver 808. A mounting stud 812 is attached to the mounting base 810. The mounting base 810 may be similar to the previously described mounting bases 310, 410, 510, 610 and 710. The mounting stud 812 may be identical or similar to the previously described mounting stud 130. As shown in FIG. 55, the suction base assembly 802 includes a suction cup 803 and support base 804. The receiver 808 is pivotally connected to the support base 804 by means of a pivot connector 805. A threaded pivot pin 806 pivotally connects the support base 804 and pivot connector 805. An internally threaded tightening handle 807 is threadingly engaged with the threaded pivot pin 806. And a friction washer 813 and standard washer 814 may be used in conjunction therewith to releasably secure the pivot connector 805 in a desired rotational orientation with respect to the support base 804. The suction base assembly 802 further includes a suction press button 815 and a button holder 816. The button holder 816 is pivotally mounted on the suction press button 815 by means of a button pin 817. The button pin 817 is mounted in vertical slots of the support base 804 such that the suction press button 815 can move vertically with respect to the support base 804. The mounting base 810 and mounting stud 812 may be attached to the receiver 808 by means of attachment screws 818. The receiver 808 is attached to the pivot connector 805 by means of a central screw 819 and lock washer 820. The suction mount assembly 800 may be secured to any suitable surface by suction force generated by the suction cup 803.

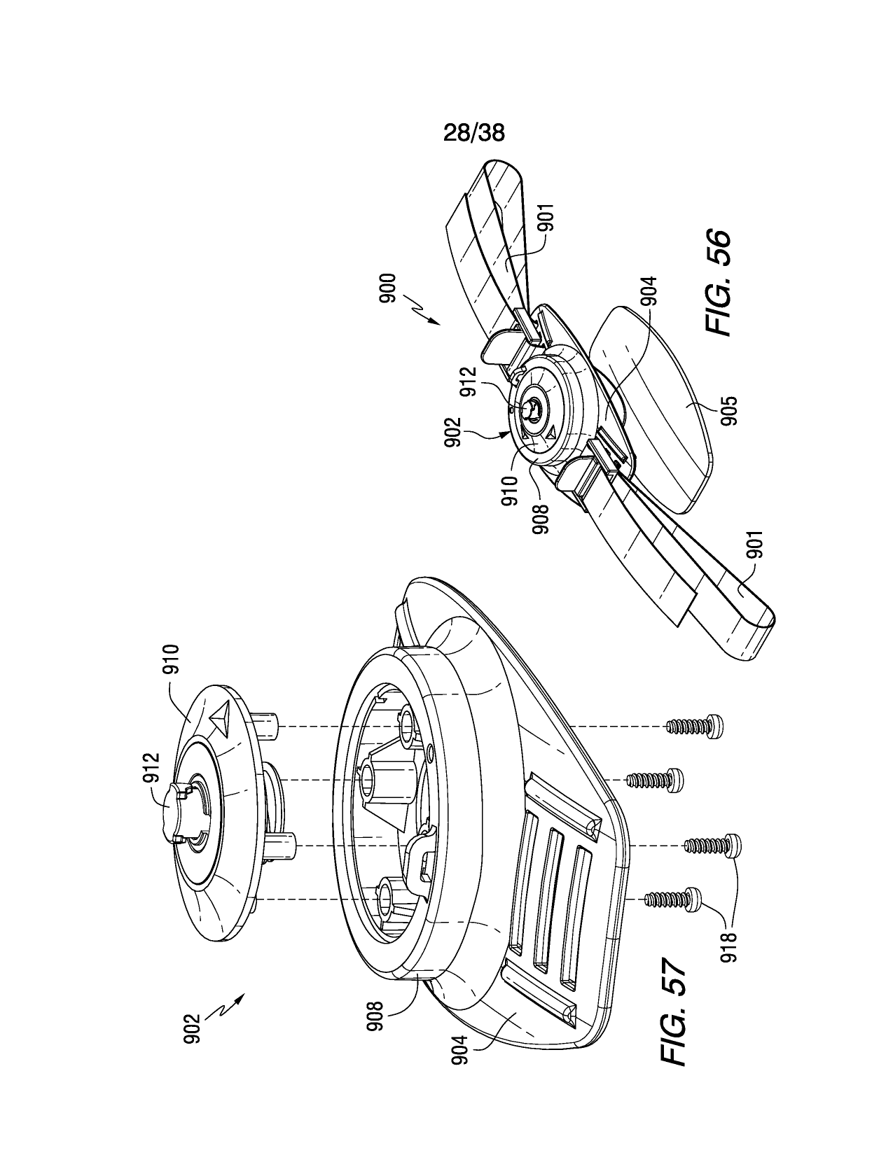

FIGS. 56 and 57 illustrate a helmet mount assembly 900 in accordance with an embodiment of the present invention. As shown in FIG. 56, the helmet mount assembly 900 includes helmet mounting straps 901 attached to a mounting bracket 902. The mounting bracket 902 includes a helmet support base 904, which is vented and has a slightly curved bottom surface in the embodiment shown. An adhesive pad 905 may be used to adhere the helmet support base 94 to a helmet (not shown) or similar structure. A receiver 908 is attached to the support base 904. A mounting base 910 and mounting stud 912 are attached to the receiver 908. The mounting base 910 may be similar to the previously described mounting bases 310, 410, 510, 610, 710 and 810. The mounting stud 912 may be identical or similar to the previously described mounting stud 130. Multiple attachment screws 918 may be used to secure the mounting base 910 to the support base 904. In the embodiment shown, the attachment screws 918 are bottom loaded in that the heads of the screws are retained against the support base 904 and their threaded ends are screwed into the mounting base 910. This is in contrast to some of the previous embodiments, in which the attachment screws are front loaded.

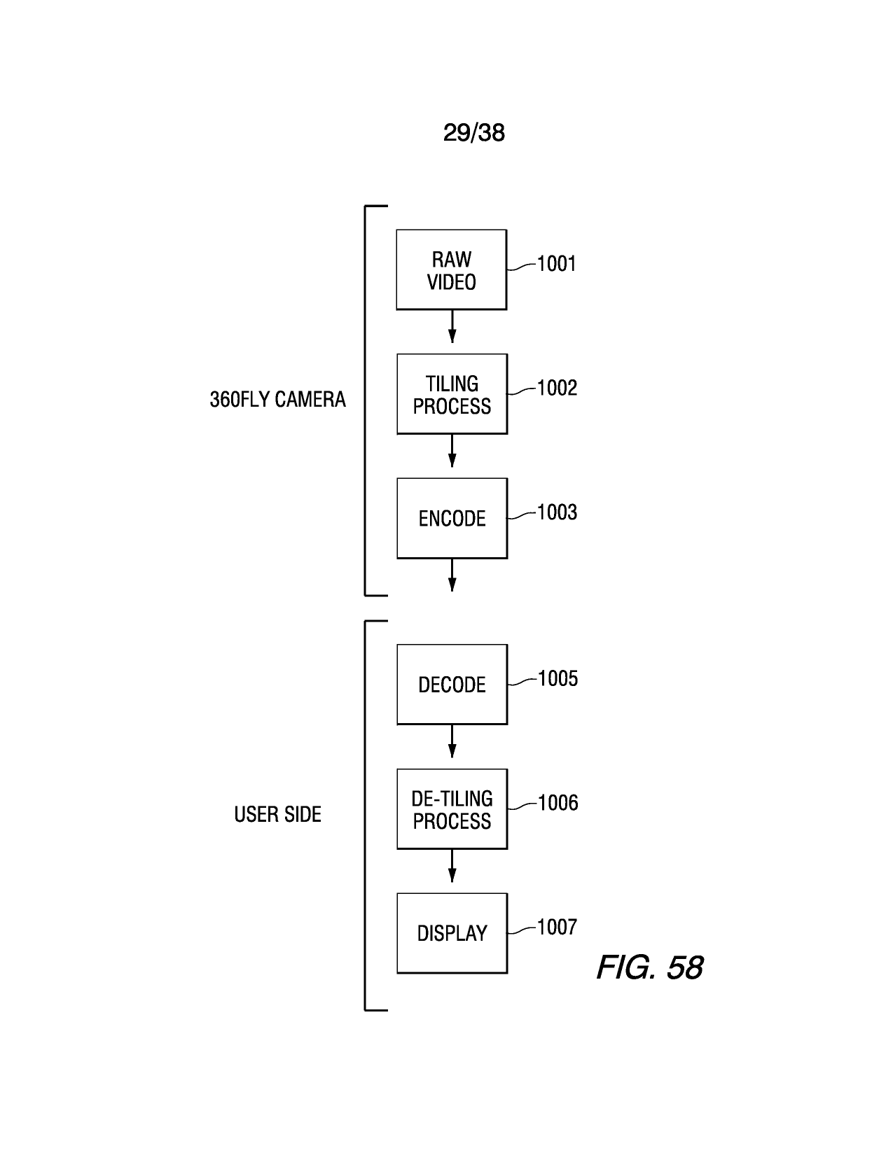

FIG. 58 illustrates an example of processing video or other audiovisual content captured by a device such as various embodiments of camera systems described herein. Various processing steps described herein may be executed by one or more algorithms or image analysis processes embodied in software, hardware, firmware, or other suitable computer-executable instructions, as well as a variety of programmable appliances or devices. As shown in FIG. 58, from the device perspective, raw video content can be captured at processing step 1001 by a user employing a camera system 10, for example. At step 1002, the video content can be tiled, or otherwise subdivided into suitable segments or sub-segments, for encoding at step 1003. The encoding process may include a suitable compression technique or algorithm and/or may be part of a codec process such as one employed in accordance with the H.264 video format, for example, or other similar video compression and decompression standards. From the user perspective, at step 1005 the encoded video content may be communicated to a user device, appliance, or video player, for example, where it is decoded or decompressed for further processing. At step 1006, the decoded video content may be de-tiled and/or stitched together for display at step 1007. In various embodiments, the display may be part of a smart phone, a computer, video editor, video player, and/or another device capable of displaying the video content to the user.

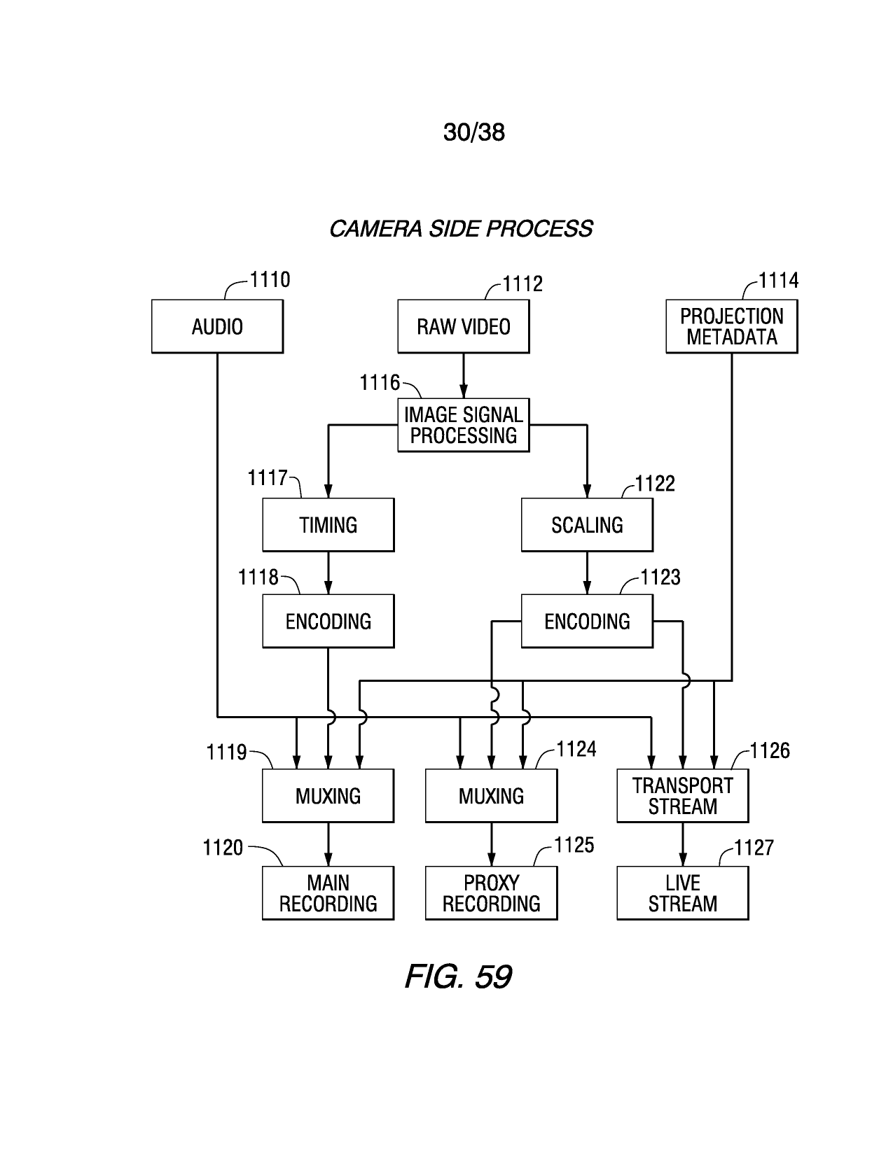

FIG. 59 illustrates various examples from the camera perspective of processing video, audio, and metadata content captured by a device which can be structured in accordance with various embodiments of cameras described herein. At step 1110, an audio signal associated with captured content may be processed which is representative of noise, music, or other audible events captured in the vicinity of the camera. At step 1112, raw video associated with video content may be collected representing graphical or visual elements captured by the camera device. At step 1114, projection metadata may be collected which comprise motion detection data, for example, or other data which describe the characteristics of the spatial reference system used to geo-reference a video data set to the environment in which the video content was captured. At step 1116, image signal processing of the raw video content (obtained from step 1112) may be performed by applying a timing process to the video content at step 1117, such as to determine and synchronize a frequency for image data presentation or display, and then encoding the image data at step 1118. In certain embodiments, image signal processing of the raw video content (obtained from step 1112) may be performed by scaling certain portions of the content at step 1122, such as by a transformation involving altering one or more of the size dimensions of a portion of image data, and then encoding the image data at step 1123.

At step 1119, the audio data signal from step 1110, the encoded image data from step 1118, and the projection metadata from step 1114 may be multiplexed into a single data file or stream as part of generating a main recording of the captured video content at step 1120. In other embodiments, the audio data signal from step 1110, the encoded image data from step 1123, and the projection metadata from step 1114 may be multiplexed at step 1124 into a single data file or stream as part of generating a proxy recording of the captured video content at step 1125. In certain embodiments, the audio data signal from step 1110, the encoded image data from step 1123, and the projection metadata from step 1114 may be combined into a transport stream at step 1126 as part of generating a live stream of the captured video content at step 1127. It can be appreciated that each of the main recording, proxy recording, and live stream may be generated in association with different processing rates, compression techniques, degrees of quality, or other factors which may depend on a use or application intended for the processed content.

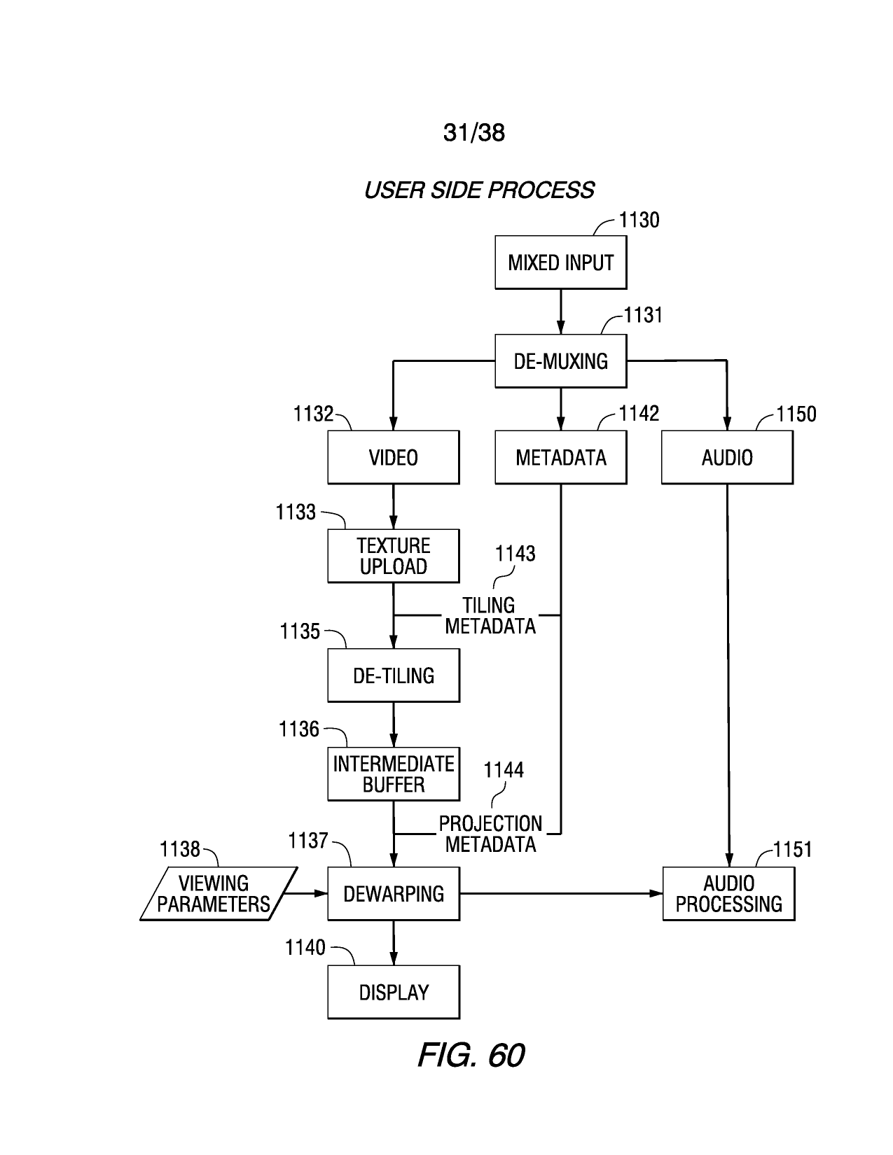

FIG. 60 illustrates various examples from the user perspective of processing video data or image data processed by and/or received from a camera device. Multiplexed input data received at step 1130 may be demultiplexed or de-muxed at step 1131. The demultiplexed input data may be separated into its constituent components including video data at step 1132, metadata at step 1142, and audio data at step 1150. A texture upload process may be applied in association with the video data at step 1133 to incorporate data representing the surfaces of various objects displayed in the video data, for example. At step 1143, tiling metadata (as part of the metadata of step 1142) may be processed with the video data, such as in conjunction with executing a de-tiling process at step 1135, for example. At step 1136, an intermediate buffer may be employed to enhance processing efficiency for the video data. At step 1144, projection metadata (as part of the metadata of step 1142) may be processed along with the video data prior to dewarping the video data at step 1137. Dewarping the video data may involve addressing optical distortions by remapping portions of image data to optimize the image data for an intended application. Dewarping the video data may also involve processing one or more viewing parameters at step 1138, which may be specified by the user based on a desired display appearance or other characteristic of the video data, and/or receiving audio data processed at step 1151. The processed video data may then be displayed at step 1140 on a smart phone, a computer, video editor, video player, virtual reality headset and/or another device capable of displaying the video content.

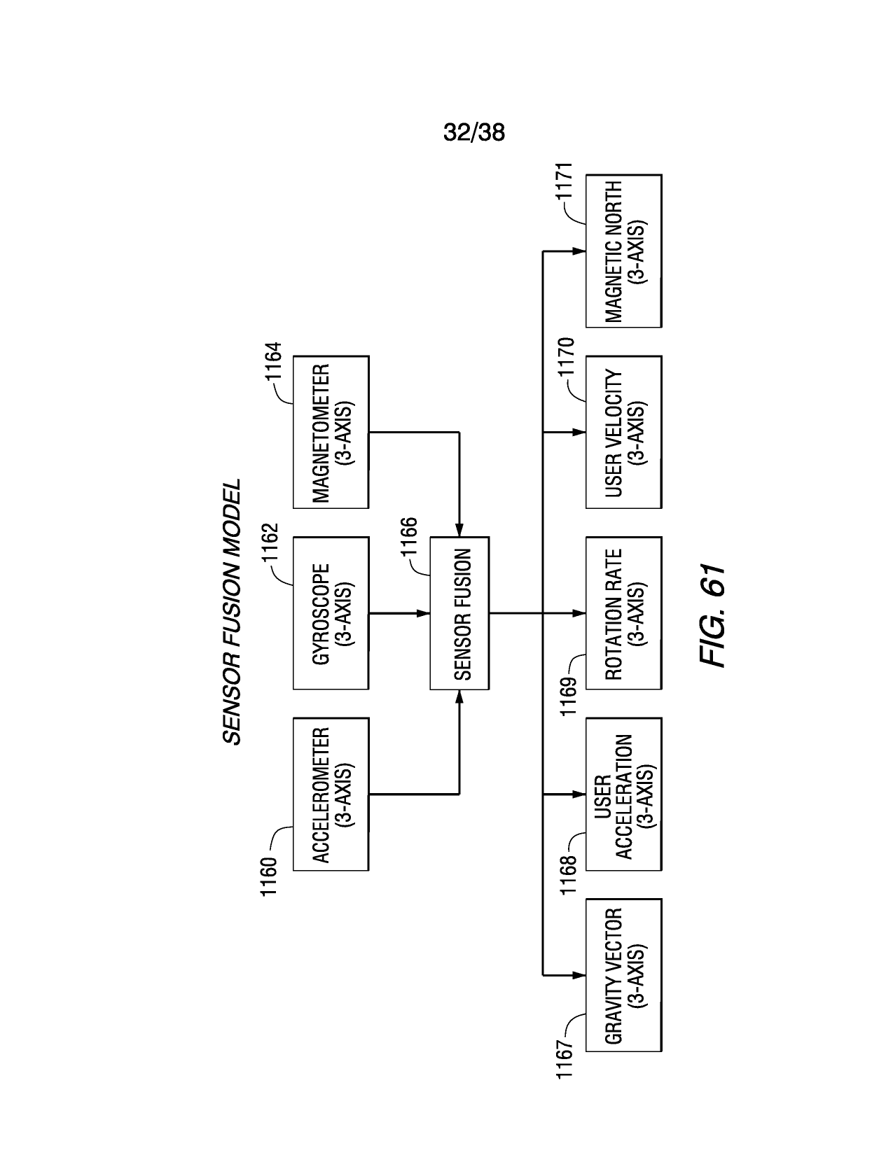

FIG. 61 depicts an example of a sensor fusion model which can be employed in connection with various embodiments of the devices and processes described herein. As shown, a sensor fusion process 1166 receives input data from one or more of an accelerometer 1160, a gyroscope 1162, or a magnetometer 1164, each of which may be a three-axis sensor device, for example. Those skilled in the art can appreciate that multi-axis accelerometers 1160 can be configured to detect magnitude and direction of acceleration as a vector quantity, and can be used to sense orientation (e.g., due to direction of weight changes). The gyroscope 1162 can be used for measuring or maintaining orientation, for example. The magnetometer 1164 may be used to measure the vector components or magnitude of a magnetic field, wherein the vector components of the field may be expressed in terms of declination (e.g., the angle between the horizontal component of the field vector and magnetic north) and the inclination (e.g., the angle between the field vector and the horizontal surface). With the collaboration or fusion of these various sensors 1160, 1162, 1164, one or more of the following data elements can be determined during operation of the camera device: gravity vector 1167, user acceleration 1168, rotation rate 1169, user velocity 1170, and/or magnetic north 1171.

The images from the camera system 10 may be displayed in any suitable manner. For example, a touch screen may be provided to sense touch actions provided by a user. User touch actions and sensor data may be used to select a particular viewing direction, which is then rendered. The device can interactively render the texture mapped video data in combination with the user touch actions and/or the sensor data to produce video for display. The signal processing can be performed by a processor or processing circuitry.

Video images from the camera system 10 may be downloaded to various display devices, such as a smart phone using an app, or any other current or future display device. Many current mobile computing devices, such as the iPhone, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off the shelf software frameworks.

User input, in the form of touch actions, can be provided to the software application by hardware abstraction frameworks on the software platform. These touch actions enable the software application to provide the user with an interactive presentation of prerecorded media, shared media downloaded or streamed from the internet, or media which is currently being recorded or previewed.

An interactive renderer may combine user input (touch actions), still or motion image data from the camera (via a texture map), and movement data (encoded from geospatial/orientation data) to provide a user controlled view of prerecorded media, shared media downloaded or streamed over a network, or media currently being recorded or previewed. User input can be used in real time to determine the view orientation and zoom. As used in this description, real time means that the display shows images at essentially the same time the images are being sensed by the device (or at a delay that is not obvious to a user) and/or the display shows images changes in response to user input at essentially the same time as the user input is received. By combining the panoramic camera with a mobile computing device, the internal signal processing bandwidth can be sufficient to achieve the real time display.

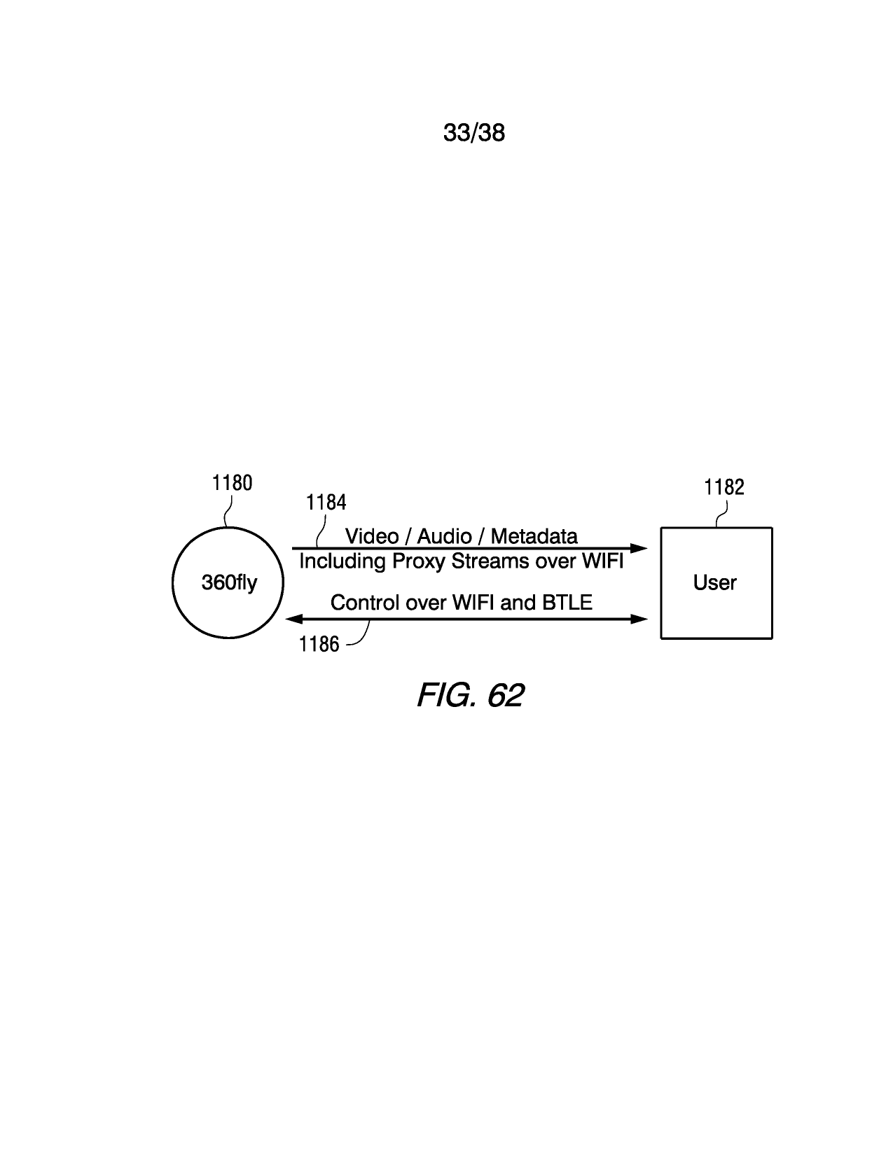

FIG. 62 illustrates an example interaction between a camera device 1180 and a user 1182 of the camera 1180. As shown, the user 1182 may receive and process video, audio, and metadata associated with captured video content with a smart phone, computer, video editor, video player, virtual reality headset and/or another device. As described above, the received data may include a proxy stream which enables subsequent processing or manipulation of the captured content subject to a desired end use or application. In certain embodiments, data may be communicated through a wireless connection (e.g., a Wi-Fi or cellular connection) from the camera 1180 to a device of the user 1182, and the user 1182 may exercise control over the camera 1180 through a wireless connection (e.g., Wi-Fi or cellular) or near-field communication (e.g., Bluetooth).

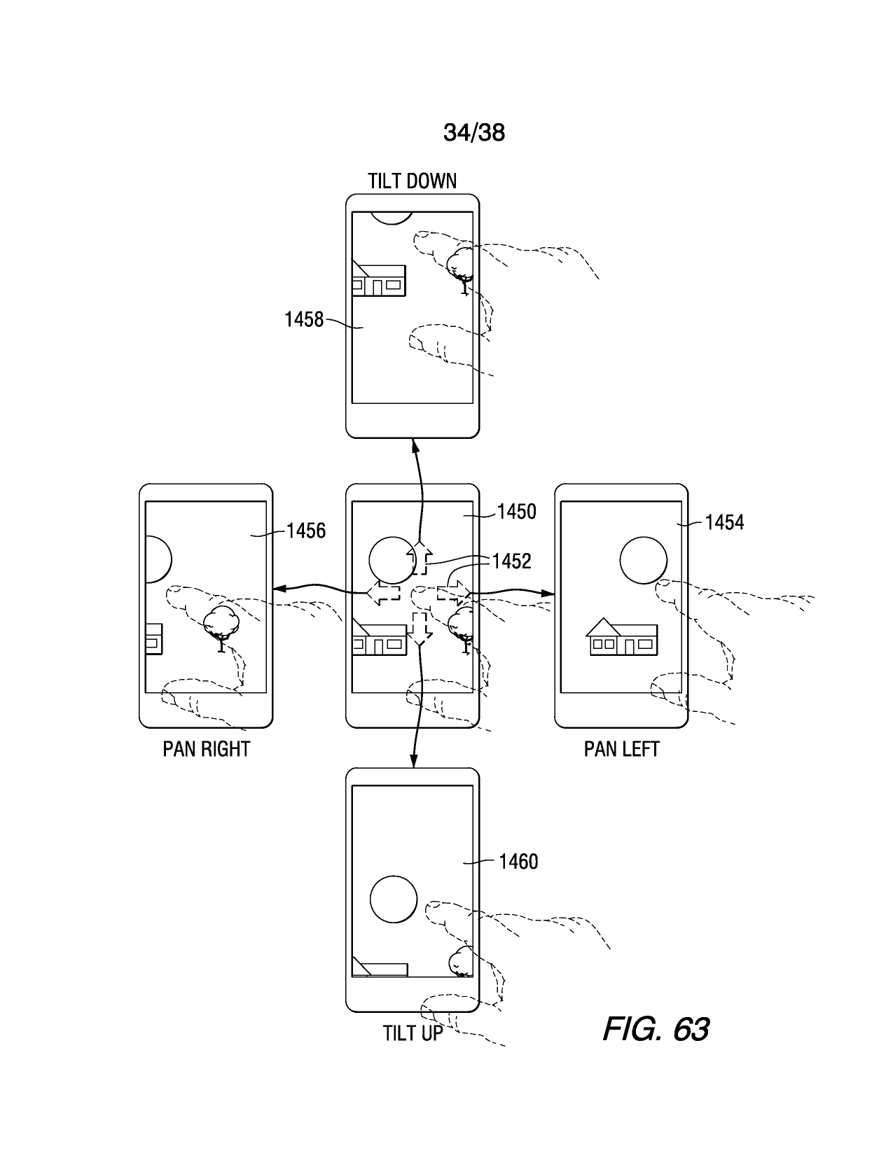

FIG. 63 illustrates pan and tilt functions in response to user commands. The mobile computing device includes a touch screen display 1450. A user can touch the screen and move in the directions shown by arrows 1452 to change the displayed image to achieve pan and/or tile function. In screen 1454, the image is changed as if the camera field of view is panned to the left. In screen 1456, the image is changed as if the camera field of view is panned to the right. In screen 1458, the image is changed as if the camera is tilted down. In screen 1460, the image is changed as if the camera is tilted up. As shown in FIG. 63, touch based pan and tilt allows the user to change the viewing region by following single contact drag. The initial point of contact from the user's touch is mapped to a pan/tilt coordinate, and pan/tilt adjustments are computed during dragging to keep that pan/tilt coordinate under the user's finger.

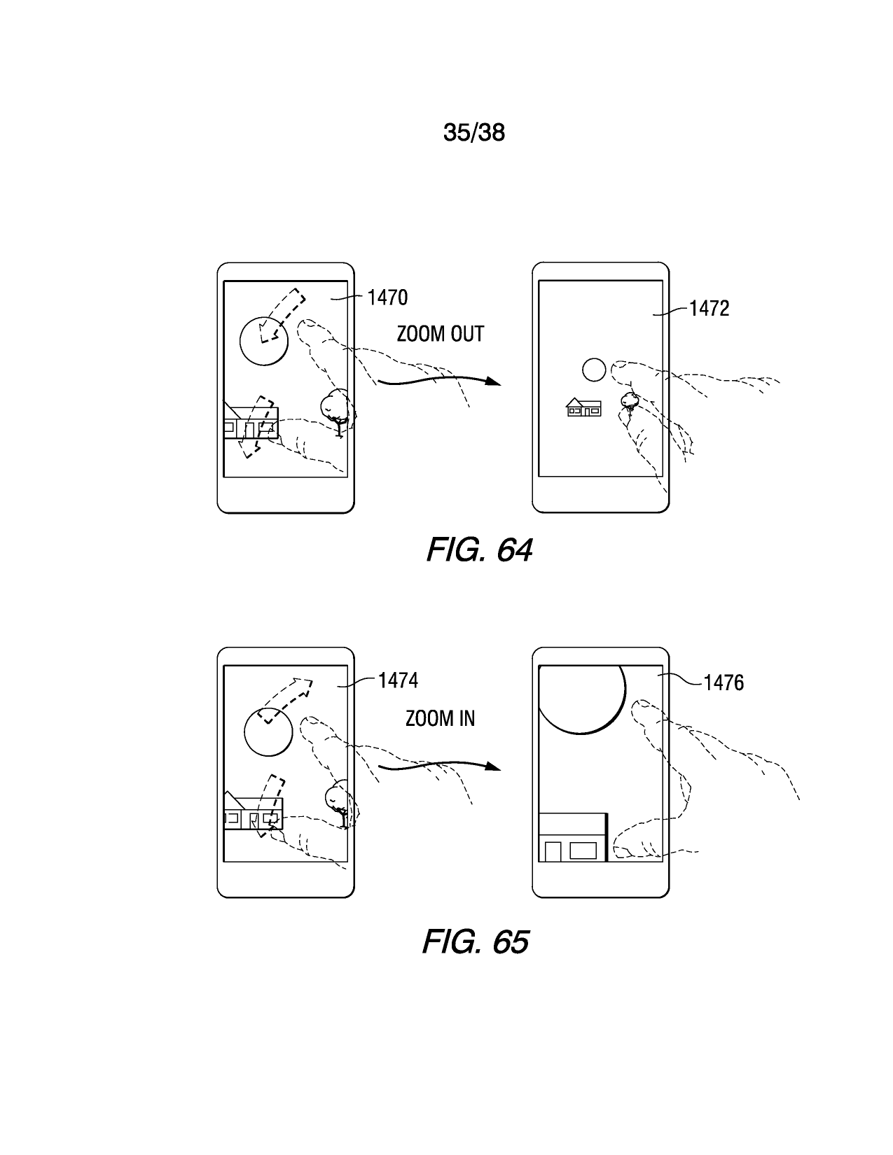

As shown in FIGS. 64 and 65, touch based zoom allows the user to dynamically zoom out or in. Two points of contact from a user touch are mapped to pan/tilt coordinates, from which an angle measure is computed to represent the angle between the two contacting fingers. The viewing field of view (simulating zoom) is adjusted as the user pinches in or out to match the dynamically changing finger positions to the initial angle measure. As shown in FIG. 64, pinching in the two contacting fingers produces a zoom out effect. That is, object in screen 1470 appear smaller in screen 1472. As shown in FIG. 65, pinching out produces a zoom in effect. That is, object in screen 1474 appear larger in screen 1476.

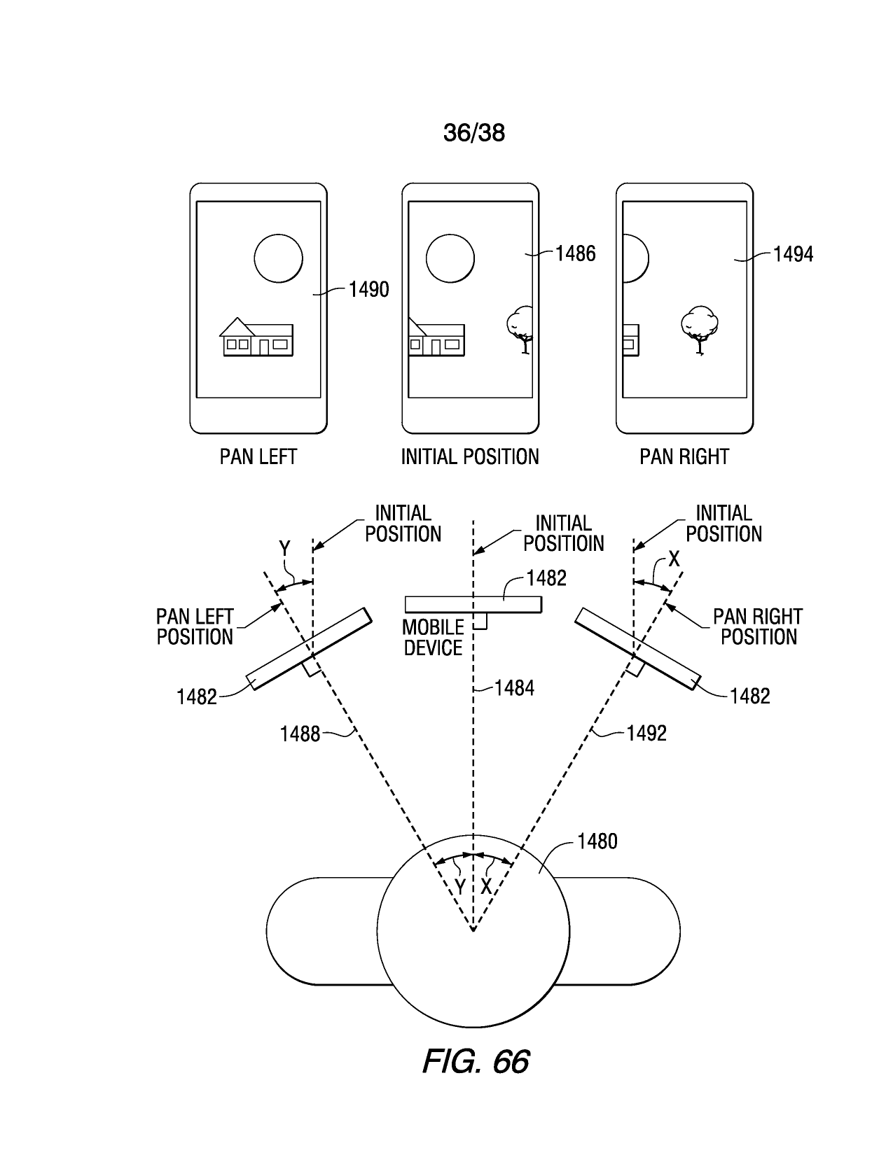

FIG. 66 illustrates an orientation based pan that can be derived from compass data provided by a compass sensor in the computing device, allowing the user to change the displaying pan range by turning the mobile device. This can be accomplished by matching live compass data to recorded compass data in cases where recorded compass data is available. In cases where recorded compass data is not available, an arbitrary north value can be mapped onto the recorded media. When a user 1480 holds the mobile computing device 1482 in an initial position along line 1484, the image 1486 is produced on the device display. When a user 1480 moves the mobile computing device 1482 in a pan left position along line 1488, which is offset from the initial position by an angle y, the image 1490 is produced on the device display. When a user 1480 moves the mobile computing device 1482 in a pan right position along line 1492, which is offset from the initial position by an angle x, the image 1494 is produced on the device display. In effect, the display is showing a different portion of the panoramic image capture by the combination of the camera and the panoramic optical device. The portion of the image to be shown is determined by the change in compass orientation data with respect to the initial position compass data.

Sometimes it is desirable to use an arbitrary north value even when recorded compass data is available. It is also sometimes desirable not to have the pan angle change 1:1 with the device. In some embodiments, the rendered pan angle may change at user-selectable ratio relative to the device. For example, if a user chooses 4x motion controls, then rotating the display device thru 90° will allow the user to see a full rotation of the video, which is convenient when the user does not have the freedom of movement to spin around completely.

In cases where touch based input is combined with an orientation input, the touch input can be added to the orientation input as an additional offset. By doing so conflict between the two input methods is avoided effectively.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

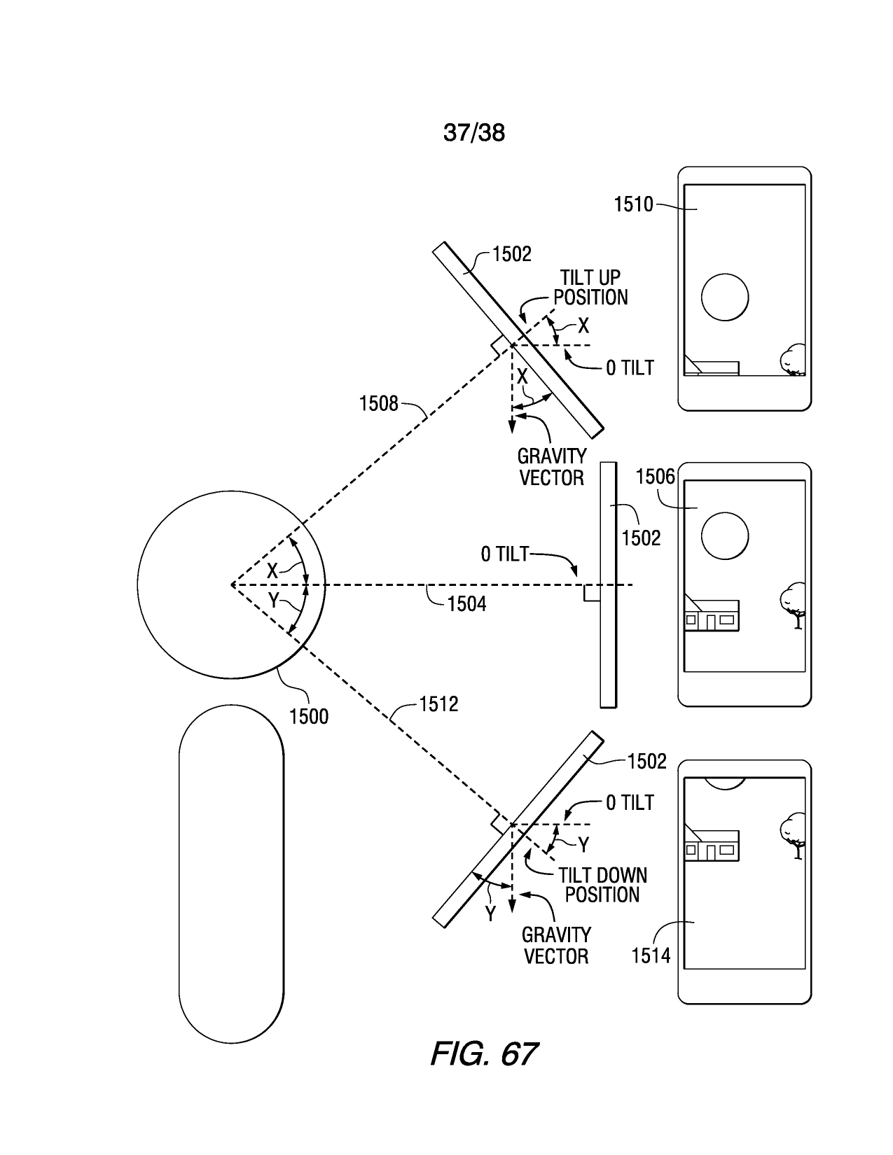

As shown in FIG. 67, orientation based tilt can be derived from accelerometer data, allowing the user to change the displaying tilt range by tilting the mobile device. This can be accomplished by computing the live gravity vector relative to the mobile device. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the phone vertically will center the view on the horizon), or it may be used with an arbitrary offset for the convenience of the operator. This offset may be determined based on the initial orientation of the device when playback begins (e.g. the angular position of the phone when playback is started can be centered on the horizon). When a user 1500 holds the mobile computing device 1502 in an initial position along line 1504, the image 1506 is produce on the device display. When a user 1500 moves the mobile computing device 1502 in a tilt up position along line 1508, which is offset from the gravity vector by an angle x, the image 1510 is produce on the device display. When a user 1500 moves the mobile computing device 1502 in a tilt down position along line 1512, which is offset from the gravity by an angle y, the image 1514 is produce on the device display. In effect, the display is showing a different portion of the panoramic image captured by the combination of the camera and the panoramic optical device. The portion of the image to be shown is determined by the change in vertical orientation data with respect to the initial position compass data.

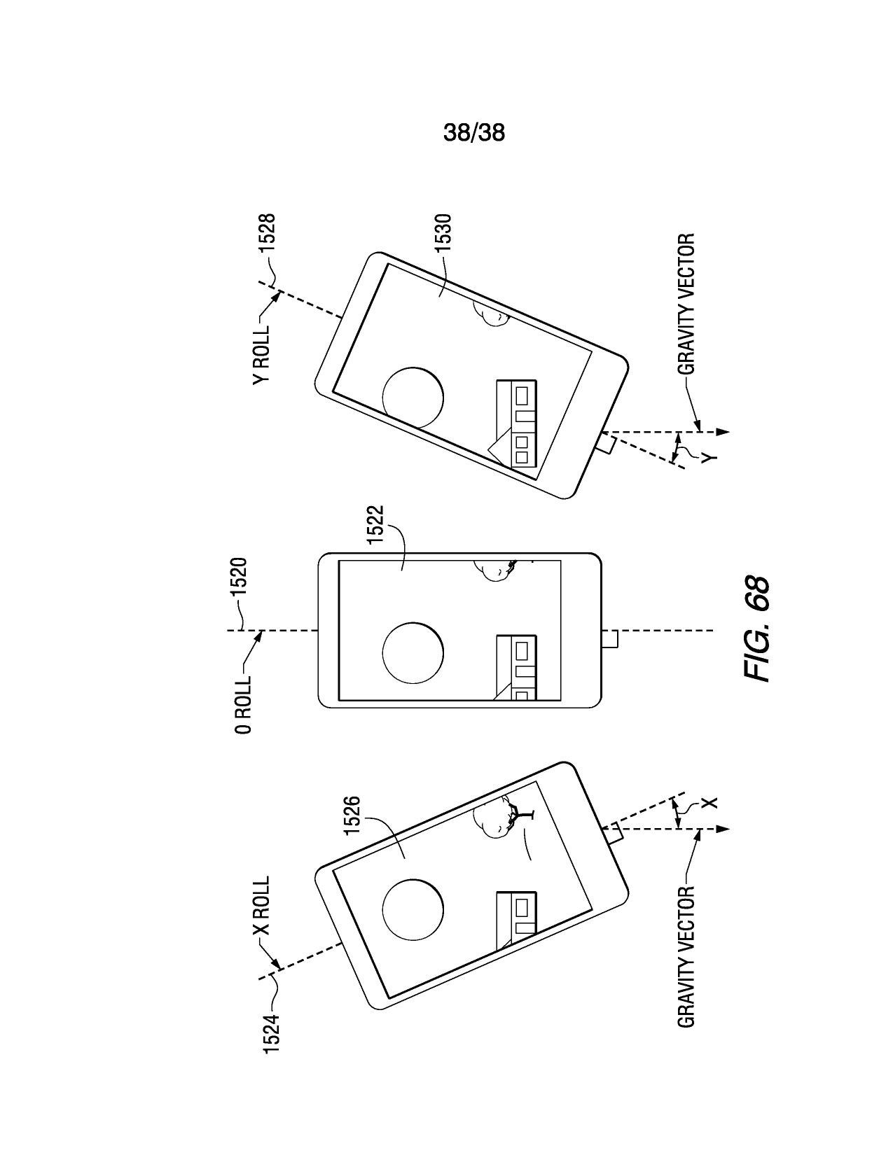

As shown in FIG. 68, automatic roll correction can be computed as the angle between the device's vertical display axis and the gravity vector from the device's accelerometer. When a user holds the mobile computing device in an initial position along line 1520, the image 1522 is produce on the device display. When a user moves the mobile computing device to an x-roll position along line 1524, which is offset from the gravity vector by an angle x, the image 1526 is produced on the device display. When a user moves the mobile computing device in a y-roll position along line 1528, which is offset from the gravity by an angle y, the image 1530 is produced on the device display. In effect, the display is showing a tilted portion of the panoramic image captured by the combination of the camera and the panoramic optical device. The portion of the image to be shown is determined by the change in vertical orientation data with respect to the initial gravity vector.

The user can select from live view from the camera, videos stored on the device, view content on the user (full resolution for locally stored video or reduced resolution video for web streaming), and interpret/re-interpret sensor data. Proxy streams may be used to preview a video from the camera system on the user side and are transferred at a reduced image quality to the user to enable the recording of edit points. The edit points may then be transferred and applied to the higher resolution video stored on the camera. The high-resolution edit is then available for transmission, which increases efficiency and may be an optimum method for manipulating the video files.

The camera system of the present invention may be used with various apps. For example, an app can search for any nearby camera system and prompt the user with any devices it locates. Once a camera system has been discovered, a name may be created for that camera. If desired, a password may be entered for the camera WIFI network also. The password may be used to connect a mobile device directly to the camera via WIFI when no WIFI network is available. The app may then prompt for a WIFI password. If the mobile device is connected to a WIFI network, that password may be entered to connect both devices to the same network.

The app may enable navigation to a “cameras” section, where the camera to be connected to WIFI in the list of devices may be tapped on to have the app discover it. The camera may be discovered once the app displays a Bluetooth icon for that device. Other icons for that device may also appear, e.g., LED status, battery level and an icon that controls the settings for the device. With the camera discovered, the name of the camera can be tapped to display the network settings for that camera. Once the network settings page for the camera is open, the name of the wireless network in the SSID field may be verified to be the network that the mobile device is connected on. An option under “security” may be set to match the network's settings and the network password may be entered. Note some WIFI networks will not require these steps. The “cameras” icon may be tapped to return to the list of available cameras. When a camera has connected to the WIFI network, a thumbnail preview for the camera may appear along with options for using a live viewfinder or viewing content stored on the camera.

In situations where no external WIFI network is available, the app may be used to navigate to the “cameras” section, where the camera to connect to may be provided in a list of devices. The camera's name may be tapped on to have the app discover it. The camera may be discovered once the app displays a Bluetooth icon for that device. Other icons for that device may also appear, e.g., LED status, battery level and an icon that controls the settings for the device. An icon may be tapped on to verify that WIFI is enabled on the camera. WIFI settings for the mobile device may be addressed in order to locate the camera in the list of available networks. That network may then be connected to. The user may then switch back to the app and tap “cameras” to return to the list of available cameras. When the camera and the app have connected, a thumbnail preview for the camera may appear along with options for using a live viewfinder or viewing content stored on the camera.

In certain embodiments, video can be captured without a mobile device. To start capturing video, the camera system may be turned on by pushing the power button. Video capture can be stopped by pressing the power button again.

In other embodiments, video may be captured with the use of a mobile device paired with the camera. The camera may be powered on, paired with the mobile device and ready to record. The “cameras” button may be tapped, followed by tapping “viewfinder.” This will bring up a live view from the camera. A record button on the screen may be tapped to start recording. To stop video capture, the record button on the screen may be tapped to stop recording.

To playback and interact with a chosen video, a play icon may be tapped. The user may drag a finger around on the screen to change the viewing angle of the shot. The video may continue to playback while the perspective of the video changes. Tapping or scrubbing on the video timeline may be used to skip around throughout the video.

Firmware may be used to support real-time video and audio output, e.g., via USB, allowing the camera to act as a live web-cam when connected to a PC. Recorded content may be stored using standard DCIM folder configurations. A YouTube mode may be provided using a dedicated firmware setting that allows for “YouTube Ready” video capture including metadata overlay for direct upload to YouTube. Accelerometer activated recording may be used. A camera setting may allow for automatic launch of recording sessions when the camera senses motion and/or sound. A built-in accelerometer, altimeter, barometer and GPS sensors may provide the camera with the ability to produce companion data files in .csv format. Time-lapse, photo and burst modes may be provided. The camera may also support connectivity to remote Bluetooth microphones for enhanced audio recording capabilities.

The panoramic camera system 10 of the present invention has many uses. The camera may be mounted on any support structure, such as a person or object (either stationary or mobile). For example, the camera may be worn by a user to record the user's activities in a panoramic format, e.g., sporting activities and the like. Examples of some other possible applications and uses of the system in accordance with embodiments of the present invention include: motion tracking; social networking; 360 mapping and touring; security and surveillance; and military applications.

For motion tracking, the processing software can be written to detect and track the motion of subjects of interest (people, vehicles, etc.) and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like YouTube or flickr). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style-one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The apparatus can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the apparatus can be mounted in portable and stationary installations, serving as low profile security cameras, traffic cameras, or police vehicle cameras. One or more devices can also be used at crime scenes to gather forensic evidence in 360° fields of view. The optic can be paired with a ruggedized recording device to serve as part of a video black box in a variety of vehicles; mounted either internally, externally, or both to simultaneously provide video data for some predetermined length of time leading up to an incident.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the apparatus can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360° heat detection.

Whereas particular embodiments of this invention have been described above for purposes of illustration, it will be evident to those skilled in the art that numerous variations of the details of the present invention may be made without departing from the invention as defined in the appended claims.

What is claimed is:

1. A panoramic camera comprising:
a camera body; and
a panoramic lens having a principle longitudinal axis and a field of view angle of greater than 180°,
wherein a portion of the camera body adjacent to the panoramic lens comprises a surface defining a rake angle that is outside the field of view angle.

2. The panoramic camera of claim 1, wherein the camera body is generally spherical.

3. The panoramic camera of claim 2, wherein the generally spherical camera body comprises multiple facets having planar surfaces.

4. The panoramic camera of claim 2, wherein the panoramic lens comprises a convex curved outer surface having a radius of curvature defining a radial length measured from the outer surface to a radial center of the lens surface, and the generally spherical camera body has a radial length measured from an outer surface of the camera body to a radial center of the camera body.

5. The panoramic camera of claim 4, wherein the convex curved outer surface of the lens is spherical.

6. The panoramic camera of claim 4, wherein the camera body radial length is larger than the lens surface radial length.

7. The panoramic camera of claim 4, wherein the radial center of the lens surface and the radial center of the camera body are located along the longitudinal axis of the lens.

8. The panoramic camera of claim 7, wherein the radial center of the lens surface and the radial center of the camera body are offset from each other along the longitudinal axis of the lens.

9. The panoramic camera of claim 1, wherein the panoramic lens has a width W_{L}, the camera body has a width W_{B}, and a ratio of W_{L}:W_{B} ranges from 1:4 to 1:0.4.

10. The panoramic camera of claim 1, wherein the lens width is at least 50 percent of the camera body width.

11. The panoramic camera of claim 1, wherein the panoramic lens has an exposed height H_{L}, the camera body has a height H_{B}, and a ratio of H_{L}:H_{B} ranges from 1:10 to 1:3.

12. The panoramic camera of claim 1, further comprising a panoramic video sensor contained in the camera body.

13. The panoramic camera of claim 1, further comprising a panoramic video processor board contained in the camera body.

14. The panoramic camera of claim 1, further comprising at least one motion sensor contained in the camera body.

15. The panoramic camera of claim 14, wherein the at least one motion sensor comprises accelerometers and/or gyroscopes.

16. The panoramic camera of claim 1, wherein the camera body comprises a mount attachment hole structured and arranged for releasable engagement to a mount assembly.

17. The panoramic camera of claim 16, wherein the mount attachment hole comprises at least one retaining tab structured and arranged to releasingly engage with a mounting stud of the mount assembly.

18. The panoramic camera of claim 1, wherein the camera body comprises at least one magnet structured and arranged to magnetically engage a charging cradle.

19. The panoramic camera of claim 18, wherein the camera body comprises a bottom surface including at least one recess or projection structured and arranged to engage at least one corresponding projection or recess of the charging cradle.

20. The panoramic camera of claim 18, wherein the camera body comprises a mount attachment hole structured and arranged to receive a central pin of the charging cradle.

21. A camera and mount assembly comprising:
a camera system comprising a camera body and a mount attachment hole therein; and
a mount assembly comprising a mounting stud including at least one cammed retention nub,
wherein the mount attachment hole comprises as least one retaining tab releasingly engageable with the at least one cammed retention nub of the mounting stud.

22. The camera and mount assembly of claim 21, wherein the mount attachment hole and mounting stud are structured and arranged to allow the camera system to be releasably locked onto the mount assembly through a rotational twisting movement of less than 180° of the camera system in relation to the mount assembly.

23. The camera and mount assembly of claim 22, wherein the rotational twisting movement is about 90°.

24. The camera and mount assembly of claim 21, wherein the mounting stud is axially extendable from a top surface of the mount assembly.

25. The camera and mount assembly of claim 24, wherein the mounting stud is spring biased into an axially retracted position in the mount assembly.

26. A camera mount assembly comprising:
a lower base; and
an upper mounting plate comprising a mounting stud extending therefrom,
wherein the mounting stud comprises at least one cammed retention nub structured and arranged for releasably retaining a mount attachment hole of camera body thereon.

27. The camera mount assembly of claim 26, wherein the upper mounting plate is movable with respect to the lower base to thereby tilt the mounting stud to a different longitudinal axis position.

28. The camera mount assembly of claim 26, further comprising a baseplate releasingly engageable with the lower baseplate.

29. The camera mount assembly of claim 28, wherein the baseplate comprises a rear surface structured and arranged for attachment to a support surface.

30. The camera mount assembly of claim 29, wherein the rear surface is concavely curved.

31. The camera mount assembly of claim 29, wherein the rear surface is substantially flat.

32. A camera mount assembly comprising:
a mounting base receiver;
a mounting base attached to the mounting base receiver; and
a mounting stud extending from the mounting base,
wherein the mounting stud comprises at least one cammed retention nub structured and arranged for releasably retaining a mount attachment hole of the camera body.

33. The camera mount assembly of claim 32, wherein the mounting base receiver is attached to a c-clamp mount, an action camera adapter mount, a tripod adapter mount, a head mount, a body mount, a suction mount or a helmet mount.

34. A camera system charging cradle comprising:
a base including bottom and top surfaces with a sidewall extending therebetween; and
a recessed nest extending inward from the top surface of the base,
wherein the recessed nest comprises at least one magnet adjacent thereto structured and arranged to magnetically attract and align the camera system in a selected orientation in the recessed nest when the camera system is placed into the recessed nest.

35. The camera system charging cradle of claim 34, wherein the recessed nest comprises at least one projection extending therefrom structured and arranged to be received in a mount attachment hole of the camera system.

36. A method for processing panoramic video content captured by a panoramic camera device, the method comprising:
executing, by a processor of the camera device, raw panoramic video associated with captured video content;
executing, by the camera device processor, a tiling process on at least a portion of the raw panoramic video;
encoding, by the camera device processor, the tiled video content;
transmitting, from the camera device to a user computing device, the encoded video content;
decoding, by a processor of the user computing device, the transmitted video content;
executing, by the user computing device processor, a de-tiling process for at least a portion of the decoded video content; and
displaying, on a display of the user computing device, at least a portion of the video content.

37. A method for processing data associated with video content captured by a panoramic camera device, the method comprising:
receiving motion sensor data associated with at least a portion of the panoramic video content captured by the camera; and
calculating at least one parameter in response to at least a portion of the received motion sensor data.

38. The method of claim 37, wherein the motion sensor data comprises accelerometer data, gyroscope data and/or magnetometer date.

39. The method of claim 37, wherein calculating the parameter includes calculating at least one gravity vector.

40. The method of claim 37, wherein calculating the parameter includes calculating at least one user acceleration value.

41. The method of claim 37, wherein calculating the parameter includes calculating at least one rotation rate value.

42. The method of claim 37, wherein calculating the parameter includes calculating at least one user velocity value.

43. The method of claim 37, wherein calculating the parameter includes calculating at least one value indicative of magnetic north.
